(19) United States
(12) Patent Application Publication
(10) Pub. No.: US 2026/0289285 A1
(43) Pub. Date: Sep. 24, 2026

(54) MEMORY SYSTEM, INFORMATION PROCESSING DEVICE, AND CONTROL METHOD FOR MEMORY SYSTEM

(71) Applicant: Kioxia Corporation, Tokyo (JP)

(72) Inventors: Yosuke BANDO, Ota Tokyo (JP); Hirotsugu KAJIHARA, Yokohama Kanagawa (JP); Kazuhiro HIWADA, Kamakura Kanagawa (JP)

(21) Appl. No.: 19/322,155

(22) Filed: Sep. 8, 2025

(30) Foreign Application Priority Data
Mar. 21, 2025 (JP) 2025-047302

(51) Int. Cl. G06N 3/0499; G06F 16/332; G06N 3/0475; G06N 3/048

(52) U.S. Cl. CPC G06N 3/0499; G06F 16/332; G06N 3/0475; G06N 3/048

(57) ABSTRACT

A memory system includes a nonvolatile memory, a processor, and a controller. The processor is configured to execute attention calculation to generate an attention indicating a correlation among words in a large language model. The controller is configured to store, in a first memory region in the nonvolatile memory, a plurality of key-value pairs used for the attention calculation, each of the key-value pairs including a first key and a first value associated with each other, control the processor to execute the attention calculation using the plurality of key-value pairs read from the nonvolatile memory and input data received from a host device, which is external to the memory system, the input data including a query, a second key, and a second value generated from a question to be processed in the large language model, and transmit output data indicating a result of the attention calculation to the host device.

### CROSS-REFERENCE TO RELATED APPLICATIONS

This application is based upon and claims the benefit of priority from Japanese Patent Application No. 2025-047302, filed Mar. 21, 2025, the entire contents of which are incorporated herein by reference.

### FIELD

Embodiments described herein relate generally to a memory system, an information processing device, and a control method for a memory system.

### BACKGROUND

A calculation processing method, a device, and a system related to generative artificial intelligence (generative AI) have been researched and proposed. For example, during inference of a large language model, the amount of data used for the inference is growing. The amount of data transferred between a processor and a memory system is increasing correspondingly.

### BRIEF DESCRIPTION OF THE DRAWINGS

FIG. 1 is a block diagram illustrating an example of a configuration of an information processing device including a memory system according to embodiments.

FIG. 2 is a block diagram illustrating an overview of a functional configuration of the information processing device.

FIG. 3 is a block diagram illustrating an example of a configuration of a memory system according to a first embodiment.

FIG. 4 is a block diagram illustrating an example of a functional configuration of the memory system according to the first embodiment.

FIG. 5 is a diagram illustrating an example of a memory space and a data structure in the memory system according to the first embodiment.

FIG. 6 is a diagram for describing an overview of various commands used in the memory system according to the first embodiment.

FIG. 7 is a diagram illustrating an example of various command formats used in the memory system according to the first embodiment.

FIG. 8 is a flowchart illustrating an example of an operation of the memory system according to the first embodiment.

FIG. 9 is a flowchart illustrating an example of attention calculation in an example of the operation of the memory system according to the first embodiment.

FIG. 10 is a sequence diagram illustrating an example of a processing sequence in an example of the operation of the memory system according to the first embodiment.

FIG. 11 is a diagram illustrating an example of an operation state of the processing sequence in an example of the operation of the memory system according to the first embodiment.

FIG. 12 is a diagram illustrating another example of an operation state of the processing sequence in an example of the operation of the memory system according to the first embodiment.

FIG. 13 is a diagram illustrating further another example of an operation state of the processing sequence in an example of the operation of the memory system according to the first embodiment.

FIG. 14 is a diagram illustrating another example of an operation state of the processing sequence in an example of the operation of the memory system according to the first embodiment.

FIG. 15 is a diagram illustrating further another example of an operation state of the processing sequence in an example of the operation of the memory system according to the first embodiment.

FIG. 16 is a sequence diagram illustrating another example of the processing sequence in an example of the operation of the memory system according to the first embodiment.

FIG. 17 is a diagram illustrating an example of an operation state of another processing sequence in an example of the operation of the memory system according to the first embodiment.

FIG. 18 is a sequence diagram for describing an example of an operation of a memory system according to a second embodiment.

FIG. 19 is a block diagram illustrating an example of a configuration of a memory system according to a third embodiment.

### DETAILED DESCRIPTION

One or more embodiments provide a memory system, an information processing device, and a control method for a memory system with improved efficiency of data transfer.

In general, according to an embodiment, a memory system includes a nonvolatile memory, a processor, and a controller. The processor is configured to execute attention calculation to generate an attention indicating a correlation among words in a large language model. The controller is electrically connected to the nonvolatile memory and the processor. The controller is configured to store, in a first memory region set in the nonvolatile memory, a plurality of key-value pairs used for the attention calculation, each of the key-value pairs including a first key and a first value associated with each other, control the processor to execute the attention calculation using the plurality of key-value pairs read from the nonvolatile memory and input data received from a host device, which is external to the memory system, the input data including a query, a second key, and a second value generated from a question to be processed in the large language model, and transmit output data indicating a result of the attention calculation to the host device.

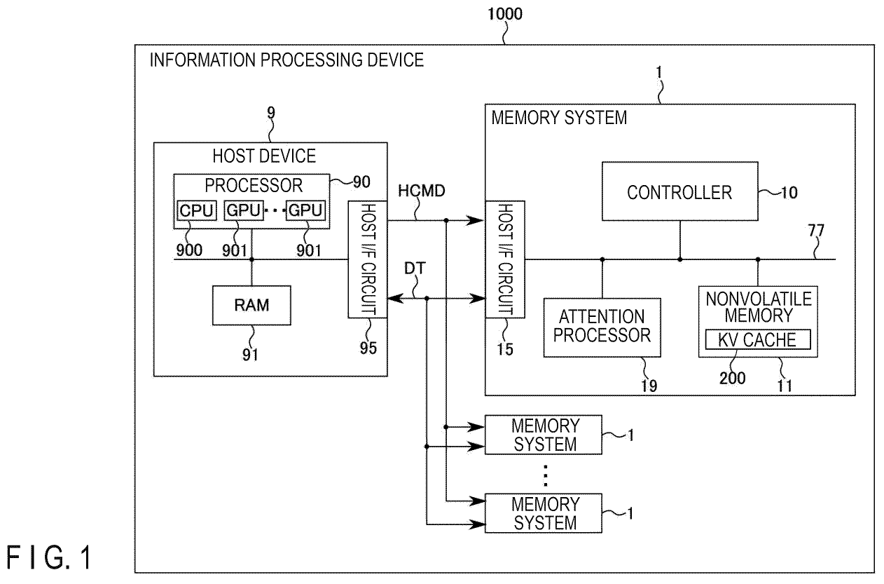

With reference to FIGS. 1 to 19, a memory system, an information processing device, and a control method for a memory system according to embodiments will be described.

In the following description, components having substantially the same functions and configurations are denoted by the same reference numerals. When the components having the same configurations are particularly distinguished from each other, different letters or numbers may be added to the end of the same reference numerals. The dimensions and ratios of the drawings are not necessarily the same as those in reality. In the following description, data may also be referred to as data items or data units.

### Embodiments

### (1) First Embodiment

With reference to FIGS. 1 to 17, a memory system, an information processing device, and a control method for a memory system according to a first embodiment will be described.

### (a) Example of Configuration

With reference to FIGS. 1 to 7, an example of a configuration of the memory system and the information processing device according to the present embodiment will be described.

(a-1) Example of Configuration of Information Processing Device

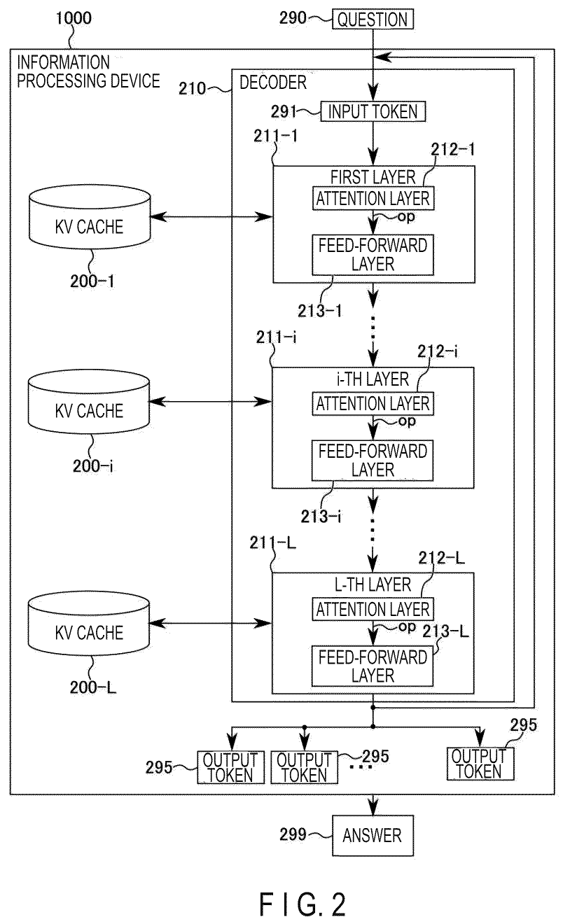

With reference to FIGS. 1 and 2, an example of the configuration of the information processing device including the memory system according to the present embodiment will be described.

FIG. 1 is a block diagram illustrating an example of a configuration of an information processing device 1000 including a memory system 1 according to the present embodiment.

The information processing device 1000 in FIG. 1 generates various pieces of information using generative artificial intelligence (generative AI). The information processing device 1000 provides the generated information to a user. For example, the information processing device 1000 generates output data (answer) based on machine learning of a large language model and/or natural language processing in response to input data (e.g., question sentence) from a user.

The information processing device 1000 includes a host device 9 and one or more memory systems 1.

The host device 9 communicates with the memory system 1 by a wired or wireless manner. For example, the host device 9 transfers data DT between the memory system 1 and the host device 9 via the Internet or an intranet. The host device 9 uses the data of the memory system 1 to perform various types of processing for generative artificial intelligence (generative AI). In the present embodiment, for example, the host device 9 executes feed-forward network processing in large language model/natural language processing.

The host device 9 includes a processor 90, a RAM 91, and an interface (I/F) circuit 95.

The processor (hereinafter, referred to as a host processor) 90 controls various types of processing and operations of the host device 9. The host processor 90 can issue commands (hereinafter, referred to as host commands) HCMD for requiring (ordering, instructing) various types of processing and operations for the memory system 1. The host processor 90 uses the data DT read from the memory system 1 to execute various types of calculation processing related to the generative AI.

The host processor 90 employs general-purpose computing on graphics processing units (GPGPUs), for example. The host processor 90 includes a CPU 900 and a plurality of GPUs 901. The CPU 900 executes various types of processing executed by the host device 9, controls the host device 9 as a whole, and controls the plurality of GPUs 901. The plurality of GPUs 901 executes various calculations by parallel processing in a certain model. The host processor 90 may further include an accelerator for supporting the calculation processing.

The RAM 91 stores data from the outside of the information processing device 1000 and data from the memory system 1. The RAM 91 functions as a working memory of the host device 9. For example, the RAM 91 is a dynamic random access memory (DRAM).

The interface circuit (hereinafter, also referred to as a host interface circuit (host I/F circuit)) 95 communicates with the memory system 1 based on a certain interface connection standard and/or a certain communication protocol. The host command HCMD for the memory system 1 is based on the interface connection standard of the host interface circuit 95. For example, the interface connection standard (or the communication protocol) used in the host interface circuit 95 is selected from a CXL^{TM} (Compute express link) standard, a PCIexpress^{TM} standard (hereinafter, referred to as a PCIe standard), an NVMexpress^{TM} standard (hereinafter, referred to as an NVMe standard), an SAS standard, an SATA standard, and an M-PHY standard applied to a UFS (Universal Flash Storage) device. Further, an interface connection standard other than the interface connection standard conforming to any of these connection standards may be used in the host interface circuit 95.

The host interface circuit 95 may include queues, for example, a submission queue (not illustrated) and a completion queue (not illustrated).

The one or more memory systems 1 according to the present embodiment store data. Each of the memory systems 1 stores a set of data of a user (for example, music, video, or documents) and a set of data used for the generative AI. For example, the memory system 1 stores a set of pairs (hereinafter, referred to as a KV cache data) including a key and a value used for calculating attention (also referred to as an attention mechanism) in the large language model/natural language processing. The attention is processing for calculating a correlation (a degree of relevance) between words in a certain sentence.

For example, the memory system 1 according to the present embodiment includes a solid-state drive (SSD). The memory system 1 includes a controller 10, a nonvolatile memory 11, an interface circuit 15, and a processor 19.

The controller 10 controls various types of processing and operations of the memory system 1. The controller 10 can issue commands (hereinafter, referred to as a memory command) for requiring (ordering, instructing) various types of processing and operations for the nonvolatile memory 11. The controller 10 can control various types of processing and operations for the processor 19.

The nonvolatile memory 11 stores data of the user (hereinafter, referred to as user data) and includes the KV cache 200. The data from the host device 9 is written to the nonvolatile memory 11 in response to a memory command from the controller 10. The data written to the nonvolatile memory 11 is read from the nonvolatile memory 11 in response to a memory command from the controller 10. For example, data for the generative AI is written to the KV cache 200 of the nonvolatile memory 11 in response to an instruction (control) from the processor 19. The data on the KV cache 200 is read from the nonvolatile memory 11 in response to an instruction (control) from the processor 19.

The Interface circuit (hereinafter, also referred to as a host interface circuit (host I/F circuit)) 15 communicates with the host device 9 based on a certain interface connection standard and/or a certain communication protocol. The data DT is transferred between the two host interface circuits 15 and 95. The interface connection standard and the communication protocol of the host interface circuit 15 are equal to (or conform to) the interface connection standard of the host interface circuit 95 of the host device 9. For example, the host interface circuit 15 may further include a plurality of circuits such as a first-in first-out (FIFO) circuit that receive commands from the host device 9.

The memory system 1 according to the present embodiment includes the processor (hereinafter, also referred to as an attention processor) 19 for calculation processing on attention. The attention processor 19 is connected to the controller 10, the nonvolatile memory 11, and the host interface circuit 15 via an internal bus (wiring) 77 within the memory system 1. The attention processor 19 includes hardware such as an electronic circuit.

The attention processor 19 executes, based on software (programs, firmware, or applications) stored in the memory system 1, a calculation on attention (hereinafter, referred to as an attention calculation) according to a query, using data related to keys and values of the KV cache 200 in the nonvolatile memory 11. The query is data in units of words (tokens) generated from the question sentence input from the user. In the present embodiment, thus, the calculation result of the attention is acquired inside the memory system 1. The attention processor 19 outputs the data DT containing calculation result (output vector) of the attention to the host device 9 via the controller 10. In addition, the attention processor 19 may be also configured to be capable of communicating with the host device 9 without going through the controller 10. The attention processor 19 may also be configured such that the attention processor 19 can order various operations to the nonvolatile memory 11 and/or another memory (for example, a RAM 101 to be described below).

The memory system 1 according to the present embodiment may also be called a storage device.

With reference to FIG. 2, processing of the generative AI executed by the information processing device 1000 will be described. FIG. 2 is a block diagram illustrating an example of a schematic functional configuration of the information processing device 1000.

As illustrated in FIG. 2, the information processing device 1000 has a function as a decoder 210 related to a machine learning of a large language model.

The decoder 210 is implemented by the memory system 1 and the host device 9 performing operations based on programs. Thus, the information processing device 1000 is configured to output an answer (answer sentence) 299 to a question (question sentence, inquiry) 290 input from the user. The decoder 210 is implemented using a neural network including a plurality of layers 211.

The question 290 and the answer 299 correspond to a natural language including one or a plurality of sentences. A sentence includes one or more words. A word includes one or more subwords. A subword corresponds to a token. A token is a unit of data when natural language is treated as data. The token represents a subword as a vector of a certain dimension. A vector encoding position information indicating the location of the subword in a natural language sentence may be added to the vector representing the token.

The decoder 210 converts the input natural language into a vector according to a context for each token. The decoder 210 generates a query, a key, and a value based on the input natural language. The decoder 210 stores the generated key and value in the memory system 1 in association with each other. The key is data for identifying the value. The value is data indicating the token. The key and the value are associated with each other one-to-one. The key is a vector (or a matrix) including one or more values. The value is a vector (or a matrix) including one or more values.

The decoder 210 generates a plurality of input tokens 291 based on the question 290. The decoder 210 executes calculation processing using a plurality of layers 211 (211-1, . . . , 211-i, . . . , and 211-L) for each of the plurality of generated input tokens 291. Here, “L” is an integer equal to or greater than 1. Here, “i” is an integer equal to or greater than 1 and equal to or less than L. The “i” is called a layer ID.

Each of the plurality of layers 211 of the decoder 210 includes, as sublayers, an attention layer 212, and a feed-forward layer 213. The attention layer 212 and the feed-forward layer 213 include neural networks.

Each of the attention layers 212 (212-1, . . . , 212-i, . . . , and 212-L) executes an attention calculation on the input token 291 or the output of the previous layer 211. Each of the attention layers 212 outputs a calculation result op of an attention.

Each of the attention layers 212 generates a key, a value, and a query from the input token 291 or the output of the previous layer 211. For example, a vector that is the input token 291 or the output of the previous layer 211 is multiplied by a matrix that generates a key, a matrix that generates a value, and a matrix that generates a query, respectively, to generate a new key, a new value, and a new query. The query is data for searching for a key. The query is a vector including one or more values.

Each of the attention layers 212 stores the key and the value in the KV cache 200 of the corresponding layer 211.

Each of the attention layers 212 executes the attention calculation using the queries, the keys, and the values corresponding to the plurality of input tokens 291 or the output of the previous layer 211. The attention calculation is performed, for example, by calculating similarity between a plurality of pairs of queries and keys and calculating a weighted sum (linear combination) of values corresponding to the keys, using weights based on the similarity between the keys and the queries.

Each of the feed-forward layers 213 (213-1, . . . , 213-i, . . . , and 213-L) executes nonlinear processing, for example, weighted multiply-accumulate computation and a rectified linear unit (ReLU) by a feed-forward neural network, on the output based on the calculation result op of the corresponding attention layer 212. The output of the feed-forward layer 213 becomes the output of the corresponding layer 211.

Each of the attention layer 212 and the feed-forward layer 213 may include additional processing, for example, layer normalization processing and skip connection.

The decoder 210 further generates new natural language (sentences or words). The decoder 210 converts the output of the final layer 211-L into an output token 295. The conversion into the output token 295 is executed, for example, by obtaining a probability distribution of subwords from the output of the final layer 211-L and selecting the subword with the highest probability. The output token 295 becomes a first subword of the output (answer) of the language model for the input data (question).

The decoder 210 receives the output token 295 as a new input token 291 and processes the plurality of layers 211. At this time, each of the attention layers 212 performs attention calculation based on a key, a value, and a query generated from the new input token 291 and the key and the value contained in the corresponding KV cache 200. Unlike the processing of the input from the user described above, the keys and the values contained in the KV cache 200 are also referenced.

The newly generated key and value are added to the KV cache 200.

The processing of the feed-forward layer 213 is as described above.

The decoder 210 converts the output of the final layer 211-L into an output token 295. The converted output token 295 becomes a second subword of the output (answer) of the language model. The second output token 295 is input again to the decoder 210, and the above-described processing is performed to generate a third output token 295.

Such processing is repeated until a special token indicating that the answer is completed, is generated.

The decoder 210 outputs the generated output tokens as an answer 299. The information processing device 1000 provides the answer 299 to the user.

The above-described example relates to the processing for outputting one answer for each input (question) from the user (the input from the user and the corresponding output are together called a sequence), but a plurality of questions may be processed simultaneously, and a plurality of answers may be generated corresponding to the plurality of questions. In this case, each step of the above-described processing is performed for every input from the user. The collective processing of such a plurality of sequences is called batch processing. Sets of the plurality of sequences to be processed collectively are called batches. In order to distinguish the batches, an identification number (hereinafter, referred to as a batch ID) is added to each of the batches.

The memory system 1 and the information processing device 1000 according to the present embodiment execute the attention calculation using the KV cache(s) 200 within the memory system 1. The memory system 1 according to the present embodiment functions as the attention layer 212 of the decoder 210. More specifically, the host device 9 performs the processing for generating a key, a value, and a query from the input token 291 or the output of the previous layer 211, and the memory system 1 performs the processing for inputting the generated key, value, and query and outputting the result of the attention calculation. Thus, the memory system 1 and the information processing device 1000 according to the present embodiment does not need to transfer data in the KV cache 200 having a large data size from the memory system 1 to the host device 9. Therefore, the memory system 1 and the information processing device 1000 can prevent a decrease in processing speed caused by the transfer of large data.

The information processing device 1000 may include a plurality of host devices 9 or a plurality of host processors 90. The plurality of host devices 9 or the plurality of host processors 90 may access one memory system 1. Another processor outside of the information processing device 1000 may access one or more memory system 1.

(a-2) Example of Configuration of Memory System

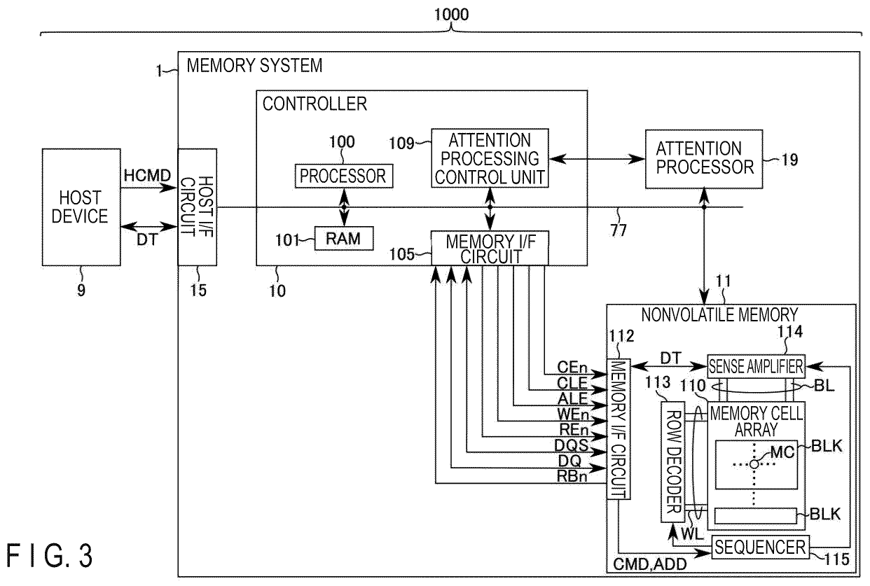

With reference to FIGS. 3 to 5, an example of the configuration of the memory system 1 according to the present embodiment will be described.

FIG. 3 is a block diagram illustrating a hardware configuration of the memory system 1 according to the present embodiment.

In the memory system 1 of FIG. 3, the controller 10 communicates with the host device 9 via the host interface circuit 15.

The controller 10 includes a processor 100, a RAM 101, an interface (I/F) circuit 105, and a control unit 109.

The processor 100 is a control circuit of the controller 10. The processor 100 is, for example, a CPU. The processor 100 executes a program (firmware and/or application) to control the operation of the controller 10 and the memory system 1 as a whole. For example, the processor 100 controls a write operation, a read operation, a delete operation, and an attention operation (to be described below) based on a request from the host device 9.

The RAM 101 is a memory that temporarily stores various pieces of data. The RAM 101 is used as a working memory in the memory system 1. The RAM 101 is, for example, a DRAM. The RAM 101 temporarily stores write data, read data, and the like. The write data is data that is written to the nonvolatile memory 11. The read data is data that is read from the nonvolatile memory 11. For example, the RAM 101 temporarily stores data read from the KV cache 200 of the nonvolatile memory 11. For example, the RAM 101 stores data related to the key and data related to the value, from the KV cache 200. In addition, the RAM 101 also stores various tables including a table that manages a correspondence relation between a logical address managed by the host device 9 and a physical address of the nonvolatile memory 11. The RAM 101 may be provided outside the controller 10 as long as being provided within the memory system 1.

The interface circuit (hereinafter, also referred to as a memory interface (memory I/F) circuit) 105 is a circuit that manages communication between the controller 10 and the nonvolatile memory 11. The memory interface circuit 105 is connected to the nonvolatile memory 11 via a bus. For example, the memory interface circuit 105 controls the transfer of control signals, data, commands, and addresses between the controller 10 and the nonvolatile memory 11.

The control unit (hereinafter, referred to as an attention processing control unit) 109 is a block for controlling the processing and operation of the attention processor 19. The attention processing control unit 109 performs various controls for attention processing by the processor 19. The attention processing control unit 109 may be configured by hardware (circuit), software (program), or both hardware and software.

The nonvolatile memory 11 is, for example, a NAND flash memory. The nonvolatile memory 11 includes a memory cell array 110, an interface circuit 112, a row decoder 113, a sense amplifier 114, and a sequencer 115.

The memory cell array 110 is a data storage region. The memory cell array 110 is electrically connected to the row decoder 113 via a plurality of word lines WL. The memory cell array 110 is electrically connected to the sense amplifier 114 via a plurality of bit lines BL. The memory cell array 110 includes a plurality of memory cells MC. Each of the memory cells MC is associated with a corresponding one word line of the plurality of word lines WL and a corresponding one bit line of the plurality of bit lines BL. In the nonvolatile memory 11, the memory cell MC can store data substantially in a nonvolatile manner. For example, a plurality of blocks BLK are configured in the memory cell array 110. The block BLK is a set of the plurality of memory cells MC. The block BLK is a data delete unit in the NAND flash memory. For example, one or more pages are assigned to one word line WL. The page is a data read unit and a data write unit in the NAND flash memory.

The interface circuit (hereinafter, also referred to as a memory interface (memory I/F) circuit) 112 controls communication between the controller 10 and the nonvolatile memory 11 based on a certain interface connection standard. The memory interface circuit 112 is electrically connected to the memory interface circuit 105 of the controller 10 via a bus.

The memory interface circuit 112 receives various control signals, commands CMD, and addresses ADD from the memory interface circuit 105. The memory interface circuit 112 receives the data DT from the memory interface circuit 105, or sends the data DT to the memory interface circuit 105. The memory interface circuit 112 sends the command CMD and the address ADD to the sequencer 115. The memory interface circuit 112 sends the data DT to the sense amplifier 114, or receives the data DT from the sense amplifier 114.

When the nonvolatile memory 11 is a NAND flash memory, the memory interface circuits 112 and 105 communicate with each other based on a Toggle DDR interface connection standard or an ONFi (Open NAND Flash interface) connection standard. For example, the memory interface circuit 112 in the NAND flash memory receives a chip enable signal CEn, a command latch enable signal CLE, an address latch enable signal ALE, a write enable signal WEn, and a read enable signal REn from the memory interface circuit 105. For example, the memory interface circuit 112 generates a strobe signal DQS based on the read enable signal REn. The memory interface circuit 112 transmits a ready/busy signal RBn to the memory interface circuit 105. A signal DQ is transferred between the memory interface circuits 112 and 105. The signal DQ is, for example, an 8-bit width signal set. The signal DQ may include the command CMD, the address ADD, the data DT, and the like.

The row decoder 113 controls a row of the memory cell array 110. The row decoder 113 controls potentials of the plurality of word lines WL according to the operation to be executed. The row decoder 113 activates, based on the address ADD, a word line WL, to which one or more memory cells MC to be operated are connected, among the plurality of word lines WL. Thus, the memory cells MC to be operated are selected.

The sense amplifier 114 controls a column of the memory cell array 110. During a write operation, the sense amplifier 114 controls potentials of the bit lines BL according to write data DT from the controller 10. During a read operation, the sense amplifier 114 reads the data DT stored in the memory cells MC, according to current and/or voltage states of the bit lines BL. The data DT read by the sense amplifier 114 is sent to the controller 10 via the interface circuit 112.

When the nonvolatile memory 11 is a NAND flash memory, the nonvolatile memory 11 may further include a voltage generation circuit that generates a relatively high voltage (for example, a voltage of 20 V or more) such as a program voltage.

The nonvolatile memory 11 may be a storage class memory instead of a NAND flash memory. For example, the nonvolatile memory 11 may be a magnetoresistive random access memory (MRAM). Instead of the nonvolatile memory 11, for example, a magnetic disc included in a hard disc drive (HDD) may be used. A plurality of nonvolatile memories 11 may be provided in the memory system 1.

The attention processor 19 is electrically connected to the attention processing control unit 109 in the controller 10. The attention processor 19 performs various types of processing and control for the attention calculation based on the control of the attention processing control unit 109. The attention processor 19 is provided as hardware in the memory system 1. The attention processor 19 can execute software.

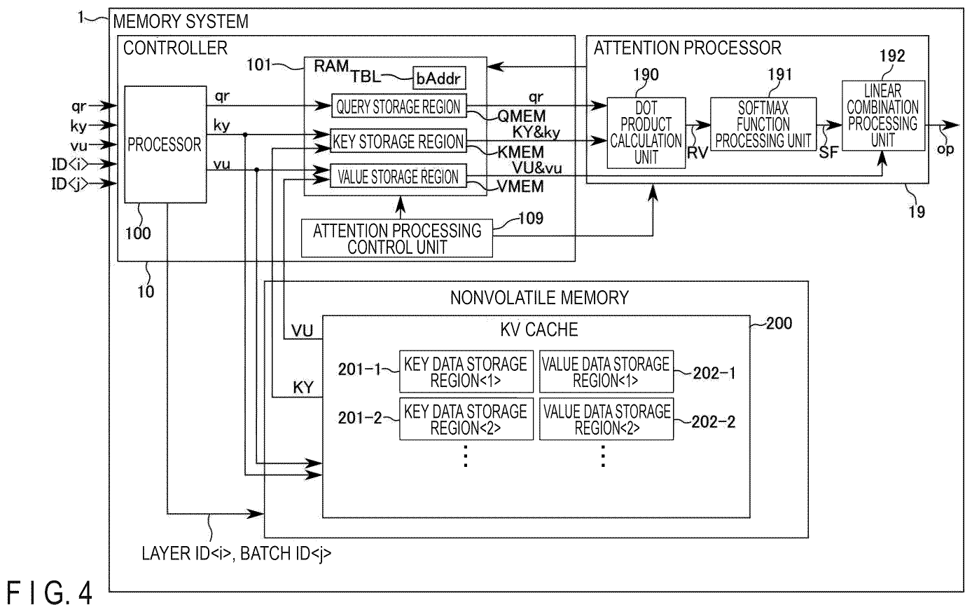

FIG. 4 is a block diagram illustrating a functional configuration related to the attention processing of the memory system 1 according to the present embodiment.

As illustrated in FIG. 4, in the memory system 1, the controller 10 receives a query (qr), a key (ky), a value (vu), a layer ID (ID<i>), and a batch ID (ID<j>) from the host device 9.

The “ky” is a vector with a certain number of dimensions indicating a value of a key. Hereinafter, the “ky” is also referred to as a key vector. The “vu” is a vector with a certain number of dimensions indicating a value of a value. Hereinafter, the “vu” is also referred to as a value vector. The “qr” is a vector with a certain number of dimensions indicating a value of a query. Hereinafter, the “qr” is also referred to as a query vector. The “j” is an integer equal to or greater than 1.

The “KY” is matrix data indicating a set of key vectors. Hereinafter, the “KY” is also referred to as a key data set or simply as key data. The “VU” is matrix data indicating a set of value vectors. Hereinafter, the “VU” is also referred to as a value data set or simply as value data. The “KY” may also be referred to as a key matrix. The “VU” may also be referred to as a value matrix. Hereinafter, a pair of key data and value data corresponding to each other in the KV cache 200 is referred to as KV cache data or simply as KV data.

The controller 10 stores the query qr, the key ky, and the value vu in the RAM 101 under the control of the processor 100. The query qr is stored in a query storage region QMEM of the RAM 101. The key ky is stored in a key storage region KMEM of the RAM 101. The value vu is stored in a value storage region VMEM of the RAM 101.

The controller 10 acquires an address (physical address) of an access target in the KV cache 200 of the nonvolatile memory 11 based on a base address (logical address) bAddr corresponding to the layer ID and the batch ID. For example, the base address bAddr corresponding to the layer ID and the batch ID is acquired from a table (hereinafter, referred to as a management table) TBL that manages the base address bAddr. The management table TBL is stored in the RAM 101, for example. The processor 100, the attention processing control unit 109, and the attention processor 19 can calculate the logical address of the access target in the KV cache 200, based on the base address bAddr and a token ID indicating which token is currently being processed, by a method to be described below. The logical address is converted into the physical address with reference to a table (logical-physical table (not illustrated)) that stores a correspondence relation between the logical address and the physical address.

The controller 10 writes the key ky and value vu from the host device 9 to the KV cache 200 corresponding to the layer ID and the batch ID.

In the nonvolatile memory 11, a designated key data storage region 201 of the KV cache 200 is accessed by the row decoder 113 and the sense amplifier 114, based on the physical address of the access target according to the layer ID and the batch ID. The nonvolatile memory 11 receives the physical address of the access target according to the layer ID and the batch ID. The nonvolatile memory 11 uses the physical address of the access target according to the layer ID and the batch ID to select a key data storage region 201 according to the layer ID and the batch ID from a plurality of key data storage regions 201-1, 201-2, . . . . The nonvolatile memory 11 writes the key ky supplied from the host device 9 into the selected key data storage region 201.

In the nonvolatile memory 11, a designated value data storage region 202 of the KV cache 200 is accessed by the row decoder 113 and the sense amplifier 114, based on the physical address of the access target according to the layer ID and the batch ID. The nonvolatile memory 11 receives the physical address of the access target according to the layer ID and the batch ID. The nonvolatile memory 11 uses the physical address of the access target according to the layer ID and the batch ID to select a value data storage region 202 according to the layer ID and the batch ID from a plurality of value data storage regions 202-1, 202-2, . . . . The nonvolatile memory 11 writes the value vu supplied from the host device 9 into the selected value data storage region 202.

The controller 10 reads the key data (a set of keys ky) KY and the value data (a set of values vu) VU used for the attention calculation, from the KV cache 200 corresponding to the layer ID and the batch ID.

In the nonvolatile memory 11, a designated key data storage region 201 of the KV cache 200 is accessed by the row decoder 113 and the sense amplifier 114, based on the physical address of the access target according to the layer ID and the batch ID. The nonvolatile memory 11 receives the physical address of the access target according to the layer ID and the batch ID. The nonvolatile memory 11 uses the physical address of the access target according to the layer ID and the batch ID to select a key data storage region 201 according to the layer ID and the batch ID from the plurality of key data storage regions 201-1, 201-2, . . . . The nonvolatile memory 11 reads the key data KY used for the attention calculation, from the selected key data storage region 201. The key data KY read from the nonvolatile memory 11 is stored in the key storage region KMEM of the RAM 101, for example.

In the nonvolatile memory 11, a designated value data storage region 202 of the KV cache 200 is accessed by the row decoder 113 and the sense amplifier 114, based on the physical address of the access target according to the layer ID and the batch ID. The nonvolatile memory 11 receives the physical address of the access target according to the layer ID and the batch ID. The nonvolatile memory 11 uses the physical address of the access target according to the layer ID and the batch ID to select a value data storage region 202 according to the layer ID and the batch ID from the plurality of value data storage regions 202-1, 202-2, . . . . The nonvolatile memory 11 reads the value data VU used for the attention calculation, from the selected value data storage region 202. The value data VU read from the nonvolatile memory 11 is stored in the value storage region VMEM of the RAM 101, for example.

The attention processor 19 includes a dot product calculation unit 190, a softmax function processing unit 191, and a linear combination processing unit 192.

The attention processor 19 receives various pieces of data used for the attention calculation from the RAM 101. The query qr is supplied from the query storage region QMEM of the RAM 101 to the dot product calculation unit 190 of the attention processor 19. The key ky and the key data KY are supplied from the key storage region KMEM of the RAM 101 to the dot product calculation unit 190. The value vu and the value data VU are supplied from the value storage region VMEM of the RAM 101 to the linear combination processing unit 192 of the attention processor 19.

The dot product calculation unit 190 acquires similarity between the key and the query by calculating a dot product (inner product) between the key and the query. The dot product calculation unit 190 receives the query (query vector qr) and the key (key data KY and key vector ky) from the controller 10 under the control of the attention processing control unit 109. The dot product calculation unit 190 calculates a dot product between the query qr and each of the plurality of keys KY and ky. The dot product calculation unit 190 sends a dot product calculation result (hereinafter, also referred to as dot product data) RV to the softmax function processing unit 191.

The softmax function processing unit 191 normalizes values included in the dot product data RV to numerical values within a predetermined range (for example, a range from 0.0 to 1.0) by performing softmax function processing on the dot product data RV. The softmax function processing unit 191 receives the dot product data RV from the dot product calculation unit 190. The softmax function processing unit 191 executes processing using a softmax function on the dot product data RV. The softmax function processing unit 191 sends a softmax function processing result (hereinafter, also referred to as normalized data) SF to the linear combination processing unit 192.

The linear combination processing unit 192 acquires numerical values through a linear combination based on the plurality of values VU and vu and the dot product between the query qr and the keys KY and ky. The linear combination processing unit 192 receives the normalized data SF from the softmax function processing unit 191. The linear combination processing unit 192 receives the value (value data VU and value vector vu) from the controller 10 under the control of the attention processing control unit 109. The linear combination processing unit 192 performs processing related to the linear combination of the normalized data SF and the value. For example, the linear combination processing unit 192 calculates a linear combination of the plurality of values VU and vu using the result of softmax processing on the dot product of the query qr and the keys KY and ky as weights (coefficients). The linear combination processing unit 192 outputs the result of the linear combination processing as output data (output vector) op indicating the calculation result of the attention.

The output data op is transferred to the host device 9 via the controller 10 and the host interface circuit 15. For example, the attention processor 19 can control the RAM 101 so as to temporarily store the output data op. The result (output data op) of the linear combination by the linear combination processing unit 192 is treated as a calculation result of the attention related to the query qr, the keys KY and ky, and the values VU and vu. The output data op is a vector.

The data size of the output data op indicating the calculation result of the attention for a certain layer is smaller than the data size of the KV cache data for such a layer.

In this way, the attention processor 19 executes the attention calculation using the various pieces of data qr, ky, KY, vu, and VU. Thus, the data (op) indicating the calculation result of the attention related to the query, the key, and the value is acquired inside the memory system 1.

As described above, when the attention processing is performed, the key data KY and the value data VU read from the KV cache 200 of the nonvolatile memory 11 are temporarily stored in the RAM 101. The read key data KY is supplied to the attention processor 19 together with the key ky supplied from the host device 9. The read value data VU is supplied to the attention processor 19 together with the value vu supplied from the host device 9.

(a-3) Arrangement of Various Pieces of Data in Nonvolatile Memory

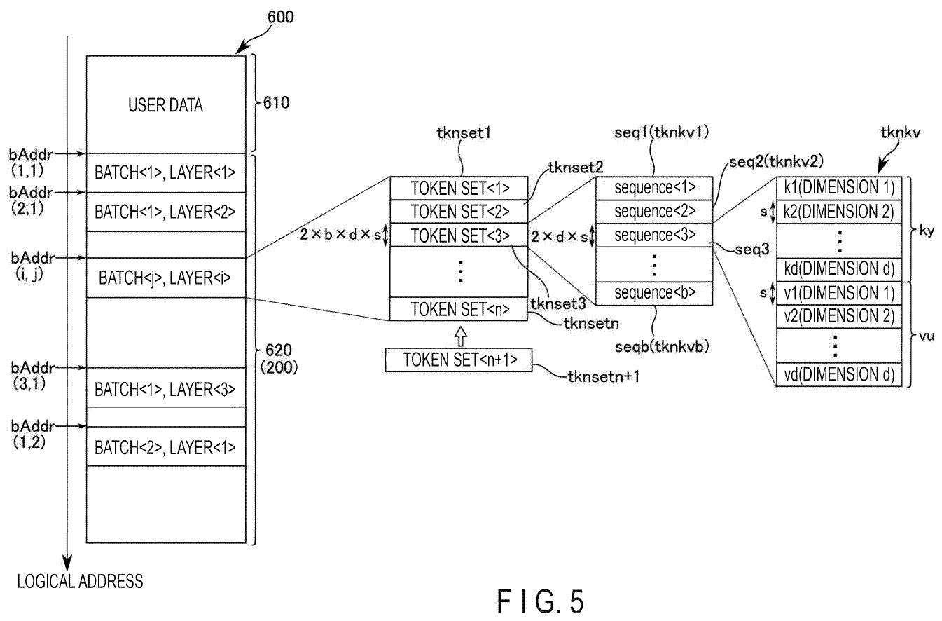

With reference to FIG. 5, a description will be made with respect to a data arrangement and a data structure in a memory space of the nonvolatile memory 11 in the memory system 1 according to the present embodiment.

FIG. 5 is a schematic diagram for describing a logical memory space 600 and a data structure of the nonvolatile memory 11 in the memory system 1 according to the present embodiment.

As illustrated in FIG. 5, the nonvolatile memory 11 includes a normal region 610 and a KV data reserve region 620 in the logical memory space 600. Logical addresses are assigned to the normal region 610 and the KV data reserve region 620.

The normal region 610 is a region that stores data (for example, music data, video data, and text data) accessible from the user.

The KV data reserve region 620 is a region that stores KV cache data (key data KY and value data VU) of the KV cache 200. The KV data reserve region 620 is a region that is configured not to be directly accessible from the user. However, the KV data reserve region 620 may be configured to be accessible from the user for debugging.

A case will be described where the nonvolatile memory 11 is a NAND flash memory. An access unit of data in the KV data reserve region 620 is set to one page or a plurality of pages. The data in the KV data reserve region 620 is read by a sequential read. For example, data is written to the KV data reserve region 620 by a sequential write. Therefore, the key and the value can be stored in a certain region of the KV data reserve region 620 with almost no data fragmentation. For example, modification of data within a page hardly occurs in the KV data reserve region 620. The data in the KV data reserve region 620 is deleted in units of block which are delete units of the NAND flash memory. With respect to the data in the KV data reserve region 620, when a block is deleted, copying data which should not be deleted within the block to another block is relatively rare.

Data of the KV data reserve region 620 (data of the KV cache 200) is excluded from a garbage collection target. For example, a degree of wear-out in the memory region (for example, the block) used for the KV data reserve region 620 may be set higher than a degree of wear-out in the memory region (for example, the block) used for the normal region 610. Even when the data of the KV cache 200 is stored in the memory region with a high degree of wear-out, a fatal effect on the attention calculation will not occur. Therefore, by assigning the KV data reserve region 620 to the memory region with a high degree of wear-out, the memory region with a high degree of wear-out in the nonvolatile memory 11 is effectively utilized.

In addition, since the KV data reserve region 620 stores temporary data, when power is unintentionally interrupted in the memory system 1, the management table TBL related to the KV data reserve region 620 and the data of the KV cache 200 transferred to the RAM 101 do not need to be stored.

A pair (KV cache data) of the key data KY and the value data VU of the KV cache 200 is stored in the KV data reserve region 620 in a hierarchized data structure.

The KV cache data is assigned to a certain logical address (base address bAddr) in the KV data reserve region 620 for each corresponding batch and each corresponding layer.

For example, a plurality of pieces of KV cache data are continuously arranged for each pair of the batch and the layer in the KV data reserve region 620. For example, the base address bAddr is managed in the memory system 1 by the management table TBL.

Access to the KV cache data in the KV data reserve region 620 can be controlled based on a base address bAddr corresponding to a layer ID and a batch ID. The data size of the key (key data) ky and the value (value data) vu corresponding to the token is constant. Therefore, based on the layer ID, the batch ID, and the token identification number (token ID), the controller 10 and the attention processor 19 can access a designated area of the KV data reserve region 620.

KV cache data of a certain batch and a certain layer can be managed in units of a plurality of sequences seq and a plurality of token sets (also referred to as token data) tknset (tknset1, tknset2, tknset3, . . . , and tknsetn). As described above, the sequence refers to units of processing for outputting one answer corresponding to one input (question) from the user. The number of sequences seq included in one batch is regarded as “b”. Since one token is generated for each of all sequences seq included in one batch, the token set tknset includes b tokens corresponding to each of the b sequences seq. When a new token set tknsetn+1 is generated, KV cache data of the token set tknsetn+1 newly generated is added to a region of the pair of corresponding batch and layer. When the number of dimensions of a vector is indicated by “d” and the data size of each vector element of each of the key and the value is indicated by “s”, the data size of the KV cache data of one token set tknset is indicated by “2×b×d×s”. For example, the data size of the KV cache data of one token set tknset has a data size within a range from 4 kB (kilobytes) to 1.6 MB (megabytes). Addresses of the plurality of token sets tknset arranged continuously in the memory space 600 are each shifted by a value corresponding to 2×b×d×s.

Each of the token sets tknset is a set of KV cache data tknkv (tknkv1, tknkv2, . . . , and tknkvb) of b tokens respectively corresponding to a plurality of sequences seq (seq1, seq2, . . . , and seqb) included in one batch. The data size of the KV cache data tknkv of one token corresponding to one sequence seq is indicated by “2×d×s”. Addresses of the plurality of sequences seq arranged continuously in the memory space 600 are each shifted by a value corresponding to 2×d×s.

The KV cache data tknkv of one token corresponding to one sequence seq includes a key ky and a value vu. The key ky is a d-dimensional vector. The key ky includes d scalar values k1, k2, . . . , and kd. The d scalar values k1, k2, . . . , and kd are arranged continuously in the memory space of one token (KV cache data) tknkv corresponding to the sequence seq. The value vu is a d-dimensional vector. The value vu includes d scalar values v1, v2, . . . , and vd. The d scalar values v1, v2, . . . , and vd are arranged continuously in the memory space of the KV cache data tknkv of one token corresponding to the sequence seq. The data size of one scalar value of the key ky is indicated by “s”. The data size of one scalar value of the value vu is indicated by “s”. Addresses of the scalar values k1, k2, . . . , and kd arranged continuously in the memory space 600 are each shifted by a value corresponding to s. Addresses of the scalar values v1, v2, . . . , and vd arranged continuously in the memory space 600 are each shifted by a value corresponding to s.

As described above, the key data KY, which is a set of keys ky, and the value data VU, which is a set of values vu, are stored in the KV data reserve region 620 of the memory space 600 of the nonvolatile memory 11. Thus, the KV cache 200 is formed.

The data at each layer in the KV cache 200 has a data size according to set parameters. Therefore, the address of data to be accessed in the KV cache 200 can be calculated in the memory system 1 from the layer ID, the batch ID, and the data size.

(a-4) Command Related to Attention Processing

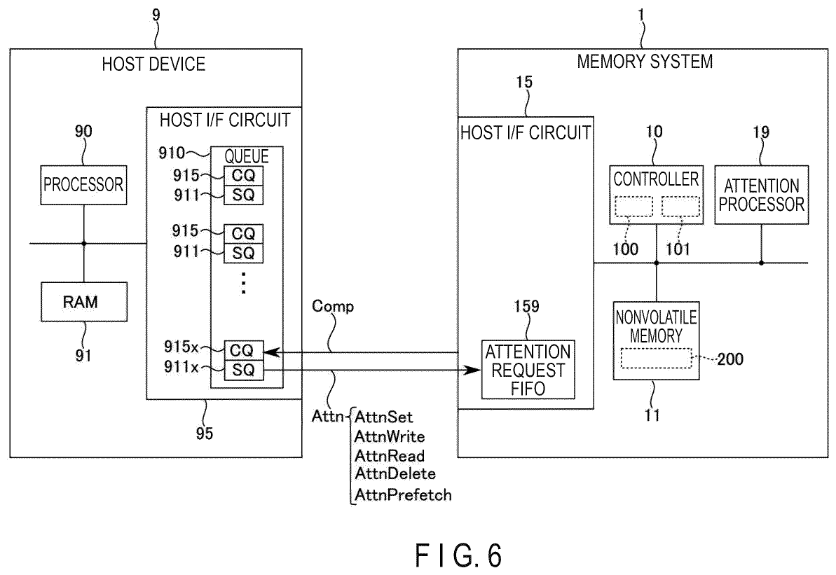

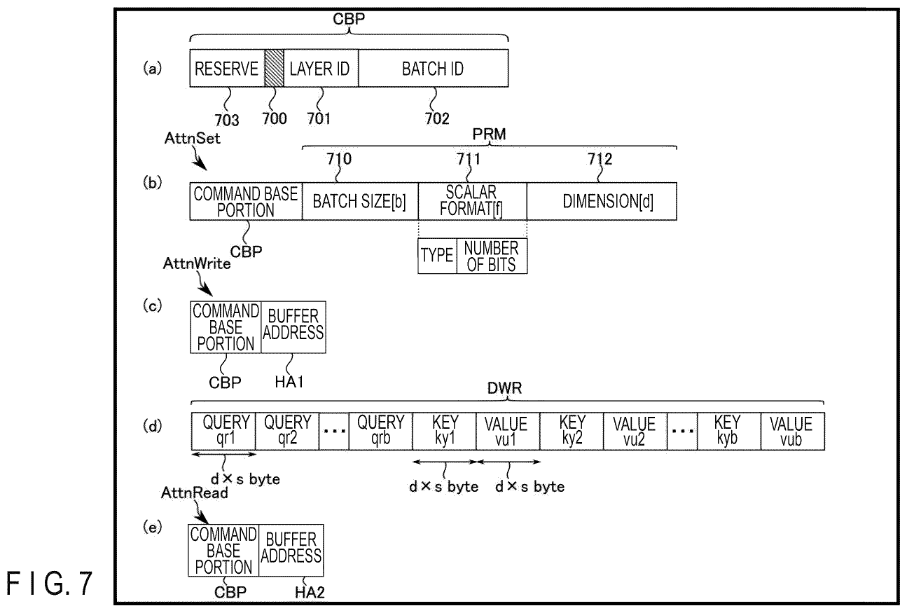

With reference to FIGS. 6 and 7, a description will be made with respect to various commands used for the attention processing of the memory system 1 according to the present embodiment.

(a-4-1) Types of Command

FIG. 6 is a diagram schematically illustrating processing of a command issued by the host device 9 to execute the attention processing in the memory system 1 according to the present embodiment.

In the memory system 1 according to the present embodiment, a plurality of commands Attn (AttnSet, AttnWrite, AttnRead, AttnDelete, and AttnPrefetch) related to the attention processing are set as host commands HCMD in order to execute the attention processing in the memory system 1.

As illustrated in FIG. 6, in the host device 9, a queue 910 is provided in the host interface circuit 95. The queue 910 includes a plurality of submission queues (SQ) 911 and 911x and a plurality of completion queues (CQ) 915 and 915x. The queue 910 may be a component of the host processor 90 or a component of the RAM 91.

Among the plurality of submission queues 911 and 911x and the plurality of completion queues 915 and 915x, specific queues 911x and 915x are designated as queues dedicated to the attention processing. Hereinafter, the submission queue 911x is referred to as an attention submission queue 911x, and the completion queue 915x is referred to as an attention completion queue 915x. One attention submission queue 911x and one attention completion queue 915x form a pair. One submission queue 911 and one completion queue 915 form a pair.

For example, a plurality of attention submission queues 911x and a plurality of attention completion queues 915x may be provided in the host interface circuit 95.

The memory system 1 according to the present embodiment treats a command (request) sent via the designated attention submission queue 911x as a command Attn for the attention processing. The memory system 1 according to the present embodiment sends a response (or status) in accordance with the attention processing, such as a completion notification Comp of the attention calculation, to the attention completion queue 915x. Hereinafter, the command Attn for the attention processing is collectively referred to as an attention command Attn.

The attention command Attn is stored in a FIFO 159 in the memory system 1. Hereinafter, the FIFO 159, in which the attention command Attn is stored, is referred to as an attention request FIFO 159. The attention request FIFO 159 is provided, for example, in the host interface circuit 15 of the memory system 1. For example, the attention request FIFO 159 is a data storage circuit such as a register. The attention request FIFO 159 can store a plurality of attention commands Attn. The attention request FIFO 159 may be a component of the processor 100 or a component of the RAM 101 of the controller 10.

An attention command AttnSet is a command for setting parameters of a certain layer (layer<i>) and a certain batch (batch<j>).

The attention command AttnSet is a command for storing parameters (b, d, f) in the memory system 1. The parameters are stored in the RAM 101 in the memory system 1, for example. The “b” is a parameter indicating a batch size. The “b” is a value indicating the number of sequences generated simultaneously in the batch to be set. For example, the “b” indicates the number of generated sentences to be treated together during generation of one token. An example of the value of “b” is 32. The “d” is a value indicating the number of dimensions of the vectors of the query (qr), the key (ky), and the value (vu). An example of the value of “d” is 12×2¹⁰. The “f” is a value indicating a format of each value (specifically, a scalar format of each value). For example, the value of “f” indicates a data type for expressing a numerical value of 32-bit floating-point type (fp32), 16-bit floating-point type (fp16), and 8-bit integer type (int8). The number of bytes (“s”) used to represent one value is determined by the value of “f”.

The attention command AttnSet is used to determine a base address for storing data of layer<i> and batch<j>. The determined base address of the layer<i> and the batch<j> is managed using the management table TBL of the RAM 101 of the memory system 1. Thus, a region for storing KV cache data of layer<i> and batch<j> is allocated in the KV data reserve region 620 of the nonvolatile memory 11. Hereinafter, the attention command AttnSet is referred to as an attention setting command AttnSet.

Based on the parameters (b, d, f) set by the attention setting command AttnSet and the base address bAddr, other commands AttnWrite, AttnRead, AttnDelete, and AttnPrefetch are received.

The attention command AttnWrite is a command to instruct the execution of the attention calculation using a query qr, a key ky, and a value vu for a certain layer<i> and a certain batch<j>. The attention command AttnWrite includes an instruction to write (add) the key ky and the value vu to the target layer<i> and batch<j>.

For example, in the attention command AttnWrite, when invalid data (for example, all 0) is set to the query qr, only the key ky and the value vu can be written without executing the attention calculation. Thus, when processing (prefill) of the question sentence is performed in bulk on the host device 9 and the result of the attention calculation in the memory system 1 is used only to generate the answer sentence as in the present embodiment, writing of only the key ky and the value vu resulting from the processing of the question sentence can be supported.

The attention calculation is executed in the memory system 1 in response to the attention command AttnWrite. Hereinafter, the attention command AttnWrite is referred to as an attention calculation execution command (or an attention write command) AttnWrite. As the execution of the attention calculation is completed, the completion notification Comp is sent from the memory system 1 to the host device 9.

The attention command AttnRead is a command to acquire a calculation result of the attention using the layer<i> and the batch<j>. The result of the attention calculation executed by the attention command AttnRead in the memory system 1 is provided to the host device 9. Hereinafter, the attention command AttnRead is referred to as an attention read command AttnRead.

The attention command AttnDelete is a command to instruct the deletion of KV cache data of a certain layer<i> and a certain batch<j>. The attention command AttnDelete invalidates a base address bAddr<i, j> corresponding to the layer<i> and the batch<j> from which the KV cache data is deleted, within the management table TBL. The KV cache data of a certain address is deleted by the attention command AttnDelete. Hereinafter, the attention command AttnDelete is referred to as an attention delete command AttnDelete.

The attention command AttnPrefetch is a command to instruct pre-reading (prefetching) of KV cache data of a certain layer<i> and a certain batch<j> from the nonvolatile memory 11 to the RAM 101. Thus, the KV cache data of a certain layer<i> and a certain batch<j> is prefetched to the RAM 101. Hereinafter, the attention command AttnPrefetch is referred to as an attention prefetch command AttnPrefetch.

(a-4-2) Command Format

FIG. 7 is a diagram illustrating an example of a command format of the attention command Attn in the memory system 1 according to the present embodiment.

As illustrated in parts (a), (b), (c), and (e) of FIG. 7, the attention command Attn is a signal group (data) having a bit length according to the type of command.

In the part (a) of FIG. 7, a command base portion CBP of the attention command Attn is illustrated. The command base portion CBP is a common portion for various attention commands Attn. The command base portion CBP is, for example, 64-bit data.

The command base portion CBP includes an operation code field 700, a layer ID field 701, a batch ID field 702, and a reserve field 703.

The operation code field 700 is, for example, a 3-bit data field. A code (value) set in the operation code field 700 indicates the type of the command (the operation to be executed by the attention processing). For example, a code of “0 (=000)” indicates the attention setting command AttnSet for setting parameters. For example, a code of “1 (=001)” indicates the attention calculation execution command AttnWrite for executing the attention calculation and writing of a key/value. For example, a code of “2 (=010)” indicates the attention read command AttnRead for reading the result of the attention calculation. For example, a code of “3 (=011)” indicates the attention delete command AttnDelete for deleting the KV cache data. For example, a code of “4 (=100)” indicates the attention prefetch command AttnPrefetch for prefetching the KV cache data.

The layer ID field 701 is a 16-bit data field. The layer number (ID<i>) is set in the layer ID field 701.

The batch ID field 702 is a 32-bit data field. The batch number (ID<j>) is set in the batch ID field 702.

The reserve field 703 is a 13-bit data field. The reserve field 703 is an unused field. However, various pieces of information used for the attention processing may be set in the reserve field 703.

In the part (b) of FIG. 7, the command format of the attention setting command AttnSet is illustrated.

The attention setting command AttnSet includes a parameter portion PRM in addition to the command base portion CBP. The parameter portion PRM includes a batch size field 710, a scalar format field 711, and a dimension field 712.

The batch size field 710 is a 16-bit data field. A value “b” indicating a batch size is set in the batch size field 710. The batch size corresponds to the number of sequences.

The scalar format field 711 is a 16-bit data field. A value “f” indicating a scalar format is set in the scalar format field 711. For example, the set value of the scalar format field 711 may be encoded to a value indicating the type of data (0: int or 1: float) and the number of required bits. For example, in an fp32 format, when the data type is indicated by “1” and the number of required bits is indicated by “32”, it is determined that the number of bytes (“s”) used to indicate the value of one key ky or one value vu is “4”. The dimension field 712 is a 32-bit data field. A value “d” indicating a dimension of the vector is set in the dimension field 712.

In the part (c) of FIG. 7, the command format of the attention calculation execution command AttnWrite is illustrated.

The attention calculation execution command AttnWrite includes a host buffer address portion HA1 in addition to the command base portion CBP.

The host buffer address portion HA1 is a 64-bit data field. An address storing data used for the attention calculation (hereinafter, referred to as write data DWR) is set in the host buffer address portion HA1. The address set in the host buffer address portion HA1 is a start address of a buffer on the host device 9.

In the part (d) of FIG. 7, the format of the write data DWR corresponding to the attention calculation execution command AttnWrite is illustrated.

The write data DWR is data used for the attention calculation and is stored in a data region in a host buffer that is set by the host device 9. Here, the host buffer is assigned on the RAM 91, for example. The write data DWR is stored at an address indicated in the host buffer address portion HA1. In the write data DWR, b queries qr1, qr2, . . . , and qrb are aligned. One query qr in the write data DWR is a d-dimensional vector. Each query qr has a data size of d×s bytes according to the set format. In the write data DWR, the query qr is followed by b pairs including a key ky and a value vu are aligned. The number of keys ky (ky1, ky2, . . . , and kyb) is b. The number of values vu (vu1, vu2, . . . , and vub) is b. Each of one key ky and one value vu in the write data DWR is a d-dimensional vector. Each key ky and each value vu has a data size of d×s bytes according to the set format.

In the part (e) of FIG. 7, the command format of the attention read command AttnRead is illustrated.

The attention read command AttnRead includes a command base portion CBP and a host buffer address portion HA2.

The host buffer address portion HA2 is a 64-bit data field. The address storing the result of the attention calculation read from the memory system 1 is set in the host buffer address portion HA2. The address set in the host buffer address portion HA2 is a start address of the buffer on the host device 9. The buffer on the host device 9 is assigned on the RAM 91, for example.

The attention delete command AttnDelete for deleting the KV cache data and the attention prefetch command AttnPrefetch for prefetching the KV cache data include only a command base portion CBP.

Various attention commands Attn having the command format as described above are issued by the host device 9. The memory system 1 according to the present embodiment performs various types of processing/operations for the attention calculation based on the issued attention commands Attn.

### (b) Example of Operation

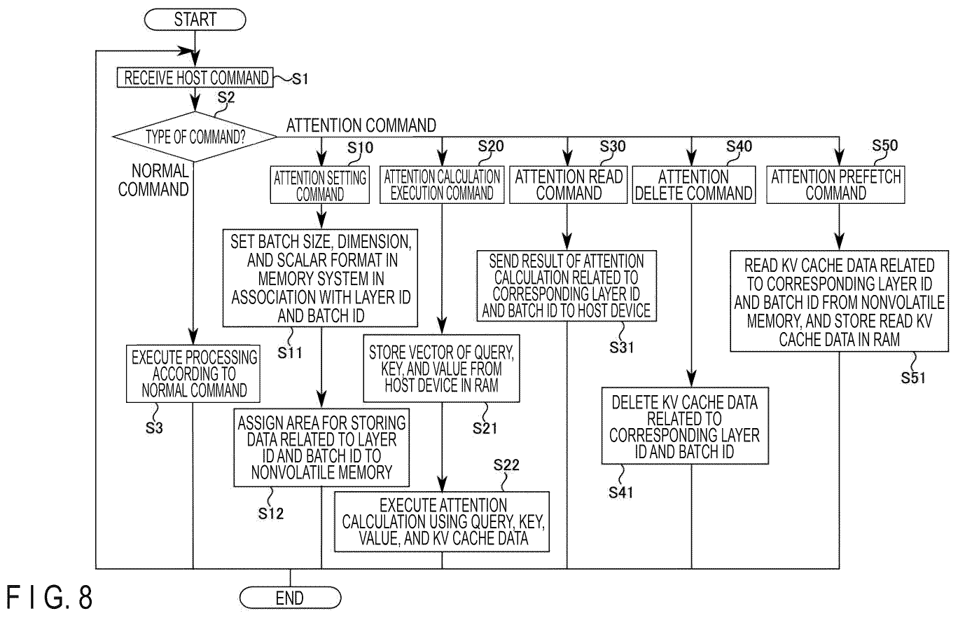

With reference to FIGS. 8 to 17, an example of the operations of the memory system 1 according to the present embodiment will be described. The example of the operations of the memory system 1 according to the present embodiment may include a control method of the memory system 1 according to the present embodiment.

(b-1) Flow of Command Processing

With reference to FIG. 8, a description will be made with respect to a flow of command processing in the example of the operation of the memory system 1 according to the present embodiment. FIG. 8 is a flowchart illustrating the flow of the command processing of the memory system 1 according to the present embodiment.

### <S1>

As illustrated in FIG. 8, the memory system 1 according to the present embodiment receives the host command HCMD issued from the host device 9.

### <S2>

The memory system 1 according to the present embodiment analyzes the type of the received host command HCMD. The memory system 1 determines whether the host command HCMD is a normal command or an attention command Attn. The normal command is, for example, a command based on the interface connection standard/protocol of two host interface circuits 15 and 95. The normal command is a command that is not the attention command Attn.

For example, when the received host command HCMD is issued from the host via the attention submission queue 911x, the memory system 1 detects that the received host command HCMD is an attention command Attn. For example, when the received host command HCMD is issued via a submission queue 911 different from the attention submission queue 911x, the memory system 1 detects that the received host command HCMD is a normal command. Alternatively, for example, when the received host command HCMD does not include the command base portion CBP, the memory system 1 detects that the received host command HCMD is a normal command. The memory system 1 detects that the received host command HCMD is an attention command Attn, for example, based on the operation code field 700 of the command base portion CBP of the received host command HCMD.

### <S3>

When the received command HCMD is the normal command, the memory system 1 executes processing according to the normal command. Such processing includes, for example, various types of processing (write operation, read operation, or delete operation) related to the user data in the normal region 610 of the memory space 600, and various settings of the memory system 1.

### <S10, S11, and S12>

When the received host command HCMD is the attention setting command AttnSet of the attention commands Attn, the memory system 1 executes processing according to the attention setting command AttnSet. In such processing, the memory system 1 sets various parameters of a batch size, a dimension, a scalar format, and the like in the memory system 1 in association with the corresponding layer ID and batch ID. In addition, the memory system 1 assigns the area for storing data related to the corresponding layer ID and batch ID to the KV data reserve region 620 of the nonvolatile memory 11.

### <S20, S21, and S22>

When the received host command HCMD is the attention calculation execution command AttnWrite of the attention commands Attn, the memory system 1 executes processing according to the attention calculation execution command AttnWrite. In such processing, the memory system 1 receives data of a query qr, a key ky, and a value vu from the host device 9. The memory system 1 stores the received data in the RAM 101. The memory system 1 adds the key ky and the value vu to the corresponding layer ID and the corresponding batch ID of the KV cache 200.

The memory system 1 uses the attention processor 19 to execute the attention calculation using the query qr, the key ky, and the value vu in the RAM 101, and the KV cache data of the corresponding layer ID and the corresponding batch ID read from the KV cache 200 of the nonvolatile memory 11.

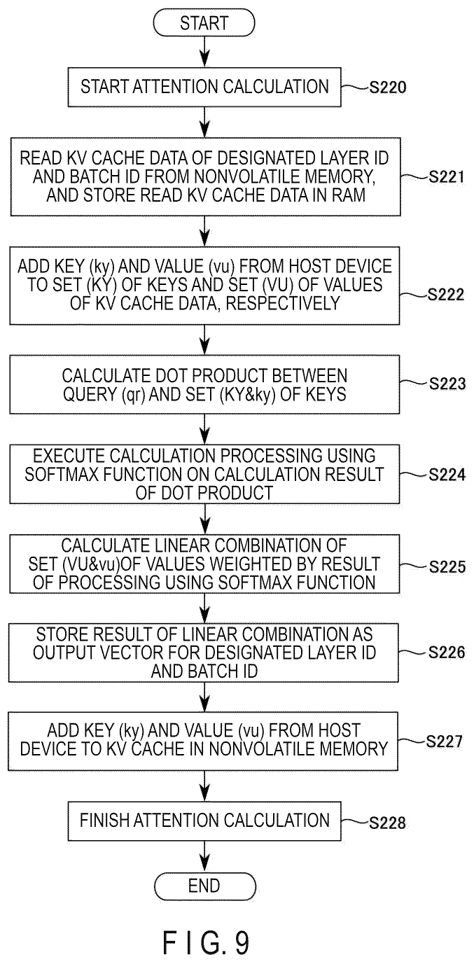

FIG. 9 is a flowchart illustrating an example of a flow of attention calculation processing.

### <S220>

The memory system 1 starts attention calculation in the memory system 1 under the control of the attention processor 19 and the attention processing control unit 109 of the controller 10.

### <S221>

The memory system 1 reads the KV cache data of the designated layer ID and batch ID, from the KV cache 200 (the key data storage region 201 and the value data storage region 202) of the nonvolatile memory 11. The memory system 1 stores the read key data KY and the read value data VU in the key storage region KMEM and the value storage region VMEM of the RAM 101, respectively.

### <S222>

The memory system 1 adds the key (key vector) ky, which is supplied together with the query qr from the host device 9, to the read key data (set of key vectors) KY. The memory system 1 adds the value (value vector) vu, which is supplied together with the query qr from the host device 9, to the read value data (set of value vectors) VU.

### <S223>

The memory system 1 uses the dot product calculation unit 190 of the attention processor 19 to calculate a dot product (inner product) between the query (qr) and each key in the set of keys (KY&ky).

### <S224>

The memory system 1 uses the softmax function processing unit 191 of the attention processor 19 to execute the calculation processing using the softmax function on the calculation result RV of the dot product. A softmax processing result SF represents similarity of each key in the set of keys (KY&ky) to the query.

### <S225>

The memory system 1 uses the linear combination processing unit 192 of the attention processor 19 to calculate a linear combination of the set of values (VU&vu) with the softmax processing result SF as weights (coefficients). In other words, each value in the set of values (VU&vu) is weighted (scaled) by the corresponding value of the softmax processing result SF, and a vector obtained by adding all the scaled values vu is output.

### <S226>

The memory system 1 stores the calculation result op of the linear combination as a result of the attention calculation for the designated layer ID and batch ID so as to be capable of outputting it to the outside. For example, the memory system 1 stores the result op of the attention calculation in the RAM 101.

### <S227>

In addition, the memory system 1 adds the key (key vector) ky and the value (value vector) vu supplied from the host device 9 to the KV cache data of the designated layer ID and batch ID in the KV cache 200 (the key data storage region 201 and the value data storage region 202) of the nonvolatile memory 11.

### <S228>

The memory system 1 ends the attention calculation by the attention processor 19.

As described above, according to the memory system 1 according to the present embodiment, the attention calculation is performed using the data of the KV cache 200 inside the memory system 1 that stores the KV cache 200. In the present embodiment, the attention may be calculated by a well-known calculation method.

Returning to FIG. 8, processing of another attention command Attn will be described.

### <S30 and S31>

When the received host command HCMD is the attention read command AttnRead of the attention commands Attn, the memory system 1 executes processing according to the attention read command AttnRead. In such processing, the memory system 1 sends the result of the attention calculation related to the corresponding layer ID and the corresponding batch ID to the host device 9 (reading).

### <S40 and S41>

When the received host command HCMD is the attention delete command AttnDelete of the attention commands Attn, the memory system 1 deletes the KV cache data related to the corresponding layer ID and the corresponding batch ID from the KV cache 200.

### <S50 and S51>

When the received host command HCMD is the attention prefetch command AttnPrefetch of the attention commands Attn, the memory system 1 reads the KV cache data related to the corresponding layer ID and the corresponding batch ID from the KV cache 200 to prefetch the data. The memory system 1 stores the read KV cache data in the RAM 101.

The memory system 1 waits for the next host command HCMD or ends the operation after each processing according to the received host command HCMD is completed.

As described above, the memory system 1 according to the present embodiment can perform the normal operation related to the user data and the attention processing operation related to the data of the KV cache 200 according to the received host command HCMD.

(b-2) Processing Sequence

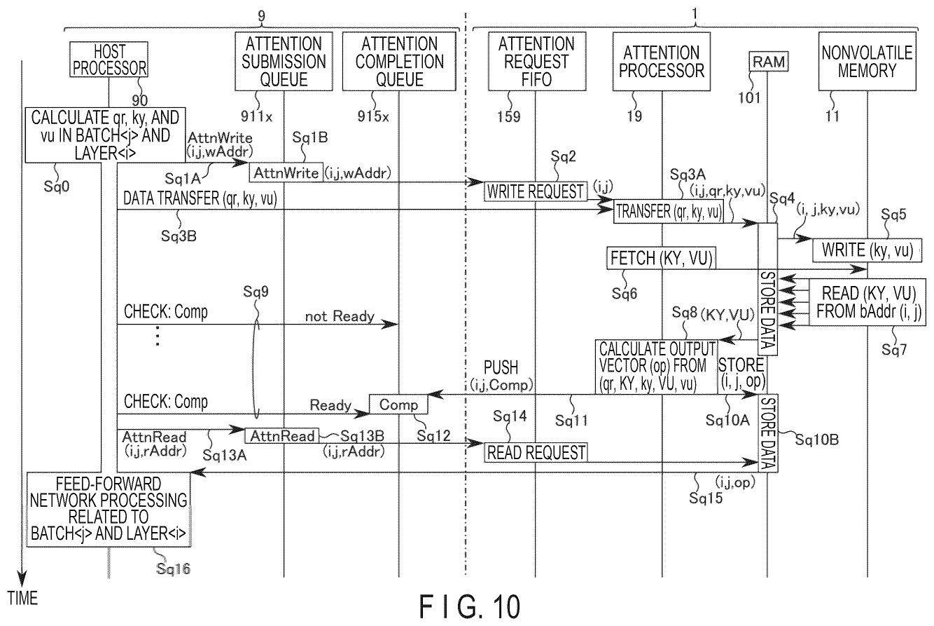

With reference to FIGS. 10 to 17, a description will be made with respect to a processing sequence in an example of operations of the memory system 1 according to the present embodiment.

(b-2-1) Basic Sequence

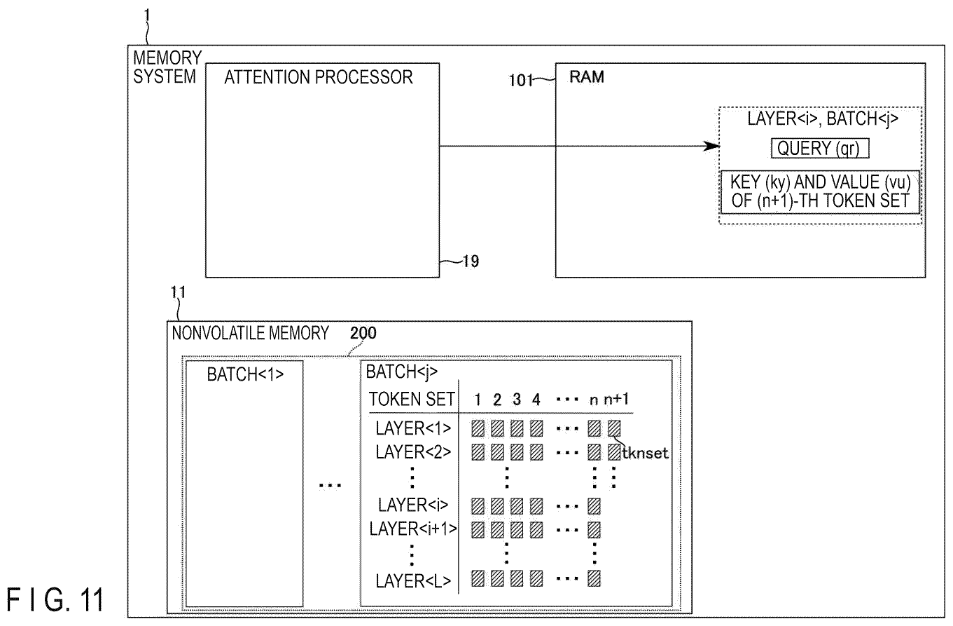

FIG. 10 is a sequence diagram illustrating a basic sequence of an example of operations of the information processing device 1000 including the memory system 1 according to the present embodiment. FIGS. 11 to 15 are schematic diagrams illustrating operation states of the components in the memory system 1 in the basic sequence of the memory system 1 according to the present embodiment.

As illustrated in FIG. 10, a basic sequence related to the attention processing of the information processing device 1000 including the memory system 1 according to the present embodiment is executed as follows.

### <Sq0>

When a question sentence is input to the host device 9 from the user, the host processor 90 in the host device 9 calculates a query qr, a key ky, and a value vu in a certain layer (a layer<i> having an i-th layer ID) and a certain batch (a batch<j> having a j-th batch ID) for the input question sentence. In the present example, the calculated query qr, key ky, and value vu are treated as values (vectors) related to the (n+1)-th token set tknsetn+1 of layer<i> and batch<j>. The memory system 1 stores, as an internal state (for example, information stored in the RAM 101), information indicating that up to the n-th token set tknsetn has already been generated for the layer<i> and the batch<j>. The host processor 90 arranges the query qr, the key ky, and the value vu in the host buffer according to the format of the write data DWR illustrated in the part (d) of FIG. 7.

### <Sq1A>

The host processor 90 generates an attention calculation execution command AttnWrite (i, j, wAddr) including a layer<i> (ID<i>), a batch<j> (ID<j>), and a host buffer address wAddr. In the part (c) of FIG. 7, “i” and “j” are set in the command base portion CBP, and “wAddr” is set in the host buffer address portion HA1. The host processor 90 sends the generated attention calculation execution command AttnWrite (i, j, wAddr) to the attention submission queue 911x.

### <Sq1B>

The attention submission queue 911x stores the attention calculation execution command AttnWrite. The attention submission queue 911x sends the attention calculation execution command AttnWrite including (i, j, wAddr) to the memory system 1 according to the present embodiment.

### <Sq2>

The memory system 1 receives the attention calculation execution command AttnWrite from the host device 9. In the memory system 1, the attention calculation execution command AttnWrite is stored in the attention request FIFO 159. The controller 10 (the processor 100) accepts a write request according to the attention calculation execution command AttnWrite. The attention request FIFO 159 sends the number (address) of the layer<i> and the batch<j> to the attention processor 19 according to the attention calculation execution command AttnWrite.

### <Sq3A and Sq3B>

The attention processor 19 receives the number of the layer<i> and the number of the batch<j> from the attention request FIFO 159.

After the attention calculation execution command AttnWrite is generated, the host device 9 sends the write data DWR including the query qr, the key ky, and the value vu on the host buffer starting at the host buffer address wAddr, to the memory system 1. The memory system 1 may initiate the transfer of the write data DWR.

In the memory system 1, the attention processor 19 (or the controller 10) receives the transferred query qr, key ky, and value vu.

As illustrated in FIG. 11, the attention processor 19 (or the controller 10) sends the query qr, the key ky, and the value vu corresponding to the layer<i> and the batch<j> to the RAM 101.

### <Sq4>

The RAM 101 stores the query qr, the key ky, and the value vu corresponding to the layer<i> and the batch<j>.

For example, the processor 100 (or the attention processor 19) in the controller 10 acquires the base address bAddr (logical address) in the nonvolatile memory 11 corresponding to the layer<i> and the batch<j>, based on the management table TBL in the RAM 101.

### <Sq5>

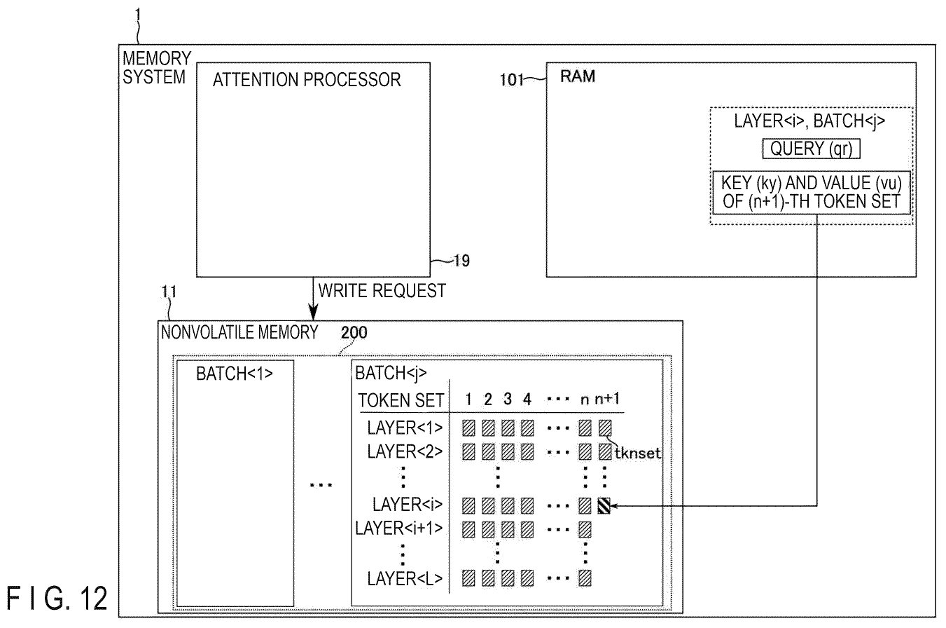

As illustrated in FIG. 12, the nonvolatile memory 11 writes, based on the instruction from the controller 10 (or the attention processor 19) in response to the write request, the value of the key ky and the value of the value vu to the corresponding region (logical address) of the KV cache 200 calculated from the base address bAddr corresponding to the layer<i> and the batch<j> as illustrated in FIG. 5. The size of the data including the key ky and the value vu to be written is 2×b×d×s. The key ky and the value vu are added to the region corresponding to the (n+1)-th token set tknsetn+1 of the layer<i> and the batch<j> of the KV cache 200. Alternatively, the key ky and the value vu may be added after the KV cache data is read from the KV cache 200 (Sq7).

### <Sq6>

The attention processor 19 fetches (reads) the KV cache data corresponding to the layer<i> and the batch<j> from the KV cache 200.

### <Sq7>

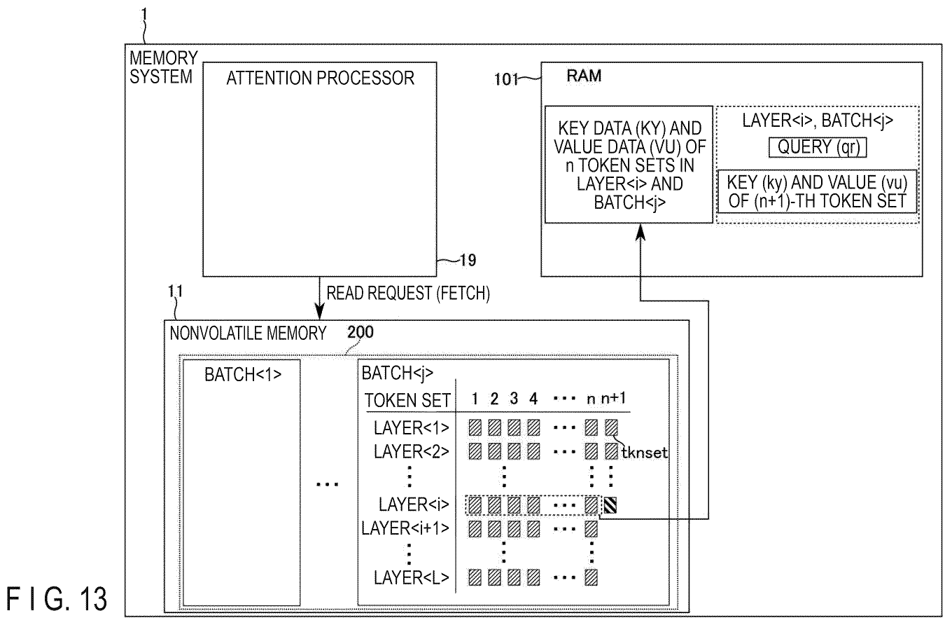

As illustrated in FIG. 13, the nonvolatile memory 11 reads the KV cache data of the layer<i> and the batch<j> under the control of the attention processor 19 and the controller 10. For example, the read KV cache data is key data KY and value data VU related to n token sets tknset. The size of the read KV cache data is 2×b×d×s×n.

The read KV cache data is loaded into the RAM 101 and stored therein.

### <Sq8>

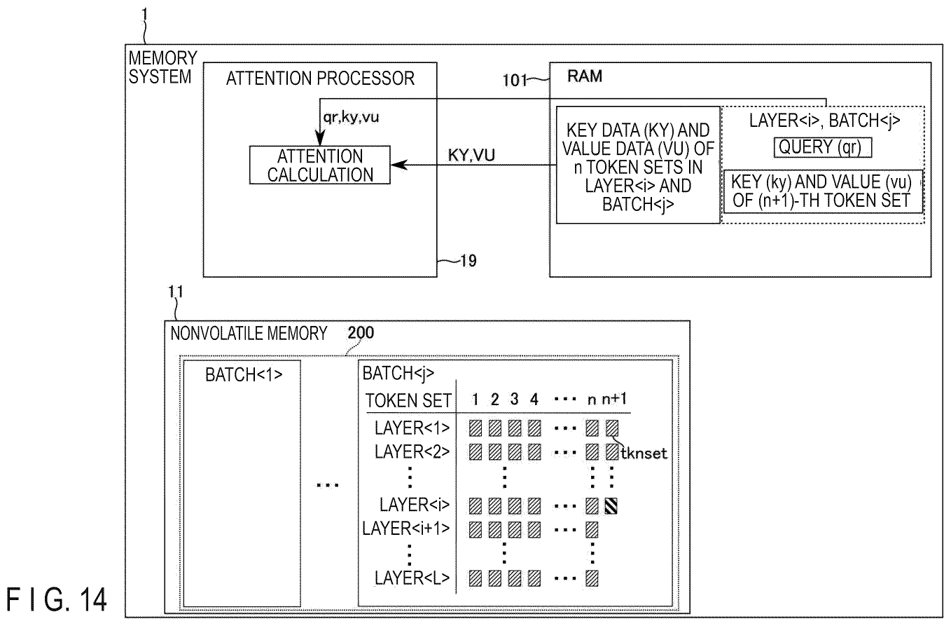

As illustrated in FIG. 14, the attention processor 19 accesses the RAM 101 and acquires the KV cache data KY and VU of the layer<i> and the batch<j>. The attention processor 19 acquires the query qr, the key ky, and the value vu corresponding to the layer<i> and the batch<j> in the RAM 101. The attention processor 19 executes the attention calculation using the acquired query qr, keys ky and KY, and values vu and VU.

### <Sq9>

The host device 9 polls the state of the attention calculation in the memory system 1 at a particular cycle. During the execution of the attention calculation in the memory system 1, the host processor 90 in the host device 9 checks attention completion queue 915x to poll the state of the attention calculation for the layer<i> and the batch<j>. When status information is not stored in the attention completion queue 915x (when the state of the attention completion queue 915x is not ready), the host device 9 determines that the attention calculation is not completed.

### <Sq10A and Sq10B>

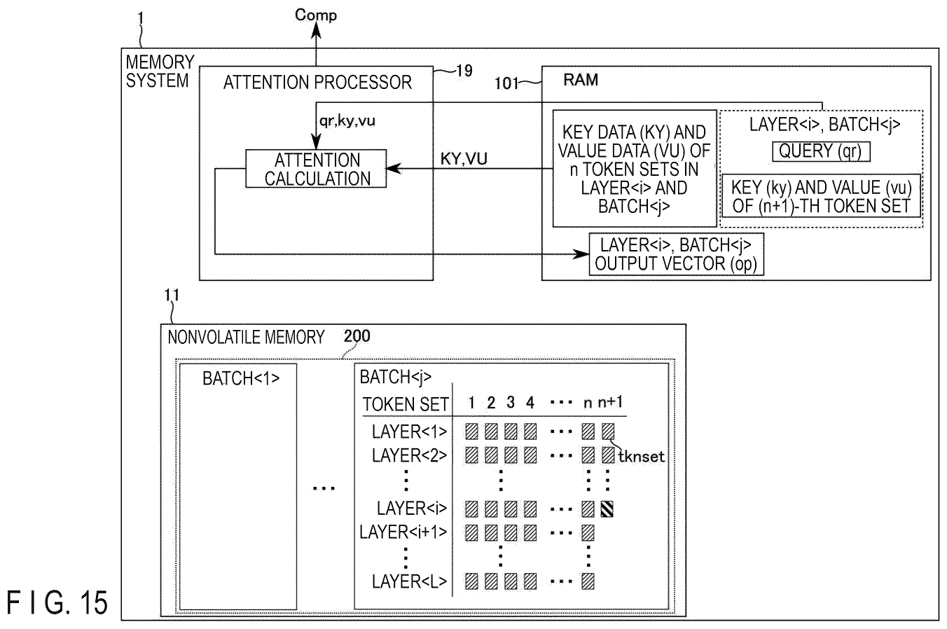

As illustrated in FIG. 15, when the attention calculation is completed, the attention processor 19 stores the output data (output vector) op indicating the result of the attention calculation for the layer<i> and the batch<j> in the RAM 101. The RAM 101 stores the output data op. The output data op may be stored in the register of the attention processor 19.

### <Sq11>

The attention processor 19 sends (pushes) the completion notification Comp of the attention calculation for the layer<i> and the batch<j> to the host device 9.

### <Sq12>

In the host device 9, the completion notification Comp related to the layer<i> and the batch<j> is stored in the attention completion queue 915x. The attention completion queue 915x stores the completion notification Comp.

The host processor 90 checks the completion notification Comp of the attention completion queue 915x by polling. When the status information is stored in the attention completion queue 915x (when the state of the attention completion queue 915x is ready), the host processor 90 detects the completion of the attention calculation in the memory system 1.

### <Sq13A>

After detecting the completion of the attention calculation, the host processor 90 generates an attention read command AttnRead (i, j, rAddr) including a layer<i>, a batch<j>, and a host buffer address rAddr. In the part (e) of FIG. 7, “i” and “j” are set in the command base portion CBP, and “rAddr” is set in the host buffer address portion HA2. The host processor 90 issues the generated attention read command AttnRead (i, j, rAddr).

### <Sq13B>

The attention read command AttnRead is supplied to the attention submission queue 911x. The attention submission queue 911x stores the attention read command AttnRead. The attention submission queue 911x sends the attention read command AttnRead including (i, j, rAddr) to the memory system 1.

### <Sq14>

The memory system 1 receives the attention read command AttnRead from the host device 9. For example, in the memory system 1, the attention read command AttnRead is stored in the attention request FIFO 159.

### <Sq15>

The controller 10 (or the attention processor 19) accepts a read request according to the attention read command AttnRead. The controller 10 reads, based on the read request, the output data op related to the layer<i> and the batch<j> in the RAM 101. The memory system 1 sends the read output data op to the host device 9 under the control of the controller 10 (or the attention processor 19). Specifically, the memory system 1 writes the output data op to the host buffer starting at the host buffer address rAddr.

### <Sq16>

The host device 9 receives the output data op of the attention calculation in the layer<i> and the batch<j>. Specifically, the host device 9 reads the output data op from the host buffer starting at the host buffer address rAddr. The host device 9 executes calculation processing on the output data op of the layer<i> and the batch<j>, using a feed-forward network of the layer<i> and the batch<j> in the feed-forward layer. Thus, the host device 9 acquires the calculation result of the feed-forward network processing related to the layer<i> and the batch<j>.

Thereafter, the host device 9 and the memory system 1 repeatedly execute the calculation processing for a predetermined number of layers and batches in the decoder 210 of the large language model.

This allows the host device 9 to acquire the answer to the question sentence.

In addition, KV cache data related to a layer<i+1> next to the layer<i> may be stored in a nonvolatile memory 11 different from the nonvolatile memory 11 that stores the KV cache data of the layer<i>. For example, the KV cache data related to odd-numbered layers of the plurality of layers may be stored in any one nonvolatile memory 11, and the KV cache data related to even-numbered layers may be stored in another nonvolatile memory 11.

KV cache data related to a batch<j+1> next to the batch<j> may be stored in a nonvolatile memory 11 different from the nonvolatile memory 11 that stores the KV cache data of the batch<j>. For example, the KV cache data related to odd-numbered batches of the plurality of batches may be stored in any one nonvolatile memory 11, and the KV cache data related to even-numbered batches may be stored in another nonvolatile memory 11.

In a plurality of memory systems 1, attentions related to a plurality of layers different from one another may be calculated, or attentions related to a plurality of batches different from one another may be calculated.

As described above, the memory system 1 and the host device 9 according to the present embodiment end the calculation processing (for example, inference) of the large language model.

(b-2-2) Processing Sequence Including Prefetch

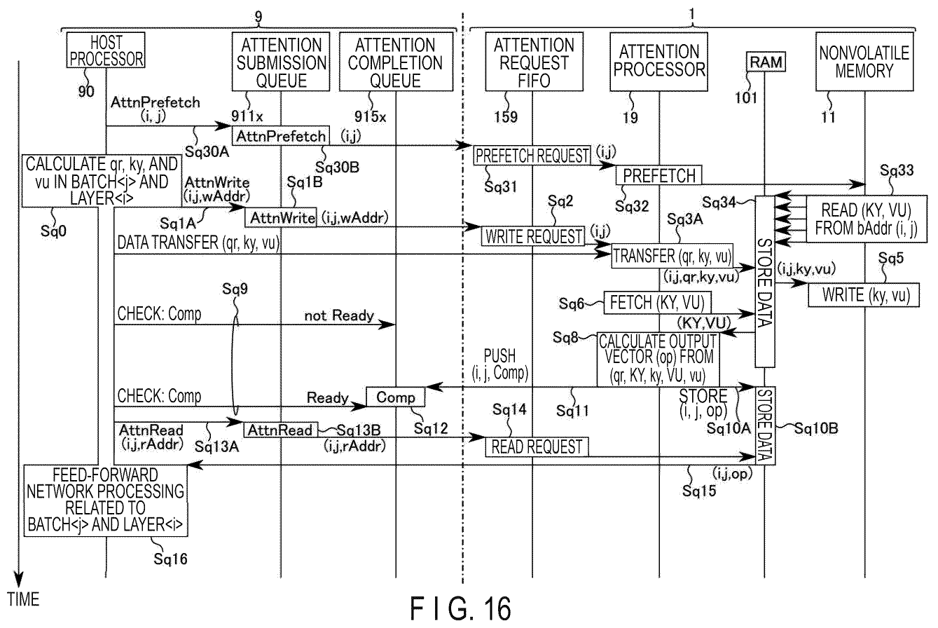

FIG. 16 is a sequence diagram illustrating a processing sequence including prefetching of an example of the operations of the information processing device 1000 including the memory system 1 according to the present embodiment.

As illustrated in FIG. 16, the processing sequence including the prefetching of the example of the operations of the information processing device 1000 including the memory system 1 according to the present embodiment includes a prefetch operation of the KV cache data in the nonvolatile memory 11. In the processing sequence of FIG. 16, prefetching is added in place of some of the processing in the sequence diagram illustrated in FIG. 10. Processing related to the prefetching added to FIG. 10 will be mainly described below.

### <Sq30A>

In the host device 9, the host processor 90 generates an attention prefetch command AttnPrefetch related to a certain layer<i> and batch<j> before calculating a query qr, a key ky, and a value vu for the input question. The host processor 90 sends the generated attention prefetch command AttnPrefetch (i, j) to the attention submission queue 911x.

### <Sq30B>

The attention submission queue 911x stores the attention prefetch command AttnPrefetch. The attention submission queue 911x sends the attention prefetch command AttnPrefetch related to the layer<i> and the batch<j> to the memory system 1 according to the present embodiment.

### <Sq31>

The memory system 1 receives the attention prefetch command AttnPrefetch from the host device 9. In the memory system 1, the attention prefetch command AttnPrefetch is stored in the attention request FIFO 159. The controller 10 (the processor 100) accepts a prefetch request according to the attention prefetch command AttnPrefetch. The attention request FIFO 159 sends the number of the layer<i> and the number of the batch<j> to the attention processor 19 according to the attention prefetch command AttnPrefetch.

### <Sq32, Sq33, and Sq34>

The attention processor 19 reads the KV cache data of the layer<i> and the batch<j> in the KV cache 200 of the nonvolatile memory 11 to the RAM 101 according to the prefetch request based on the attention prefetch command AttnPrefetch. The nonvolatile memory 11 reads the KV cache data of the layer<i> and the batch<j> under the control of the attention processor 19 and the controller 10. The read KV cache data of the layer<i> and the batch<j> is stored in the RAM 101.

In parallel with the prefetching of the KV cache data in the memory system 1, the host device 9 calculates, in Sq0, the query qr, the key ky, and the value vu of the layer<i> and the batch<j> with respect to the question sentence.

After the calculation of the query qr, the key ky, and the value vu is completed, as in Sq1A and Sq1B described above, the host processor 90 of the host device 9 issues the attention calculation execution command AttnWrite related to the layer<i> and the batch<j>. The issued attention calculation execution command AttnWrite is supplied to the attention request FIFO 159 of the memory system 1 as in Sq2 described above via the attention submission queue 911x.

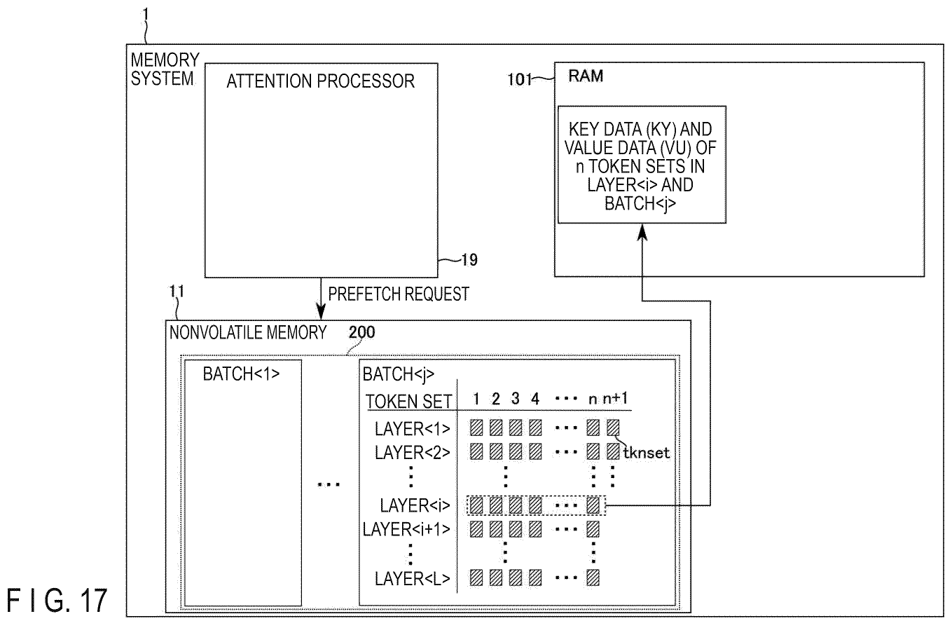

For example, as illustrated in FIG. 17, the prefetching of the KV cache data for the layer<i> and the batch<j> is completed before the query qr, the key ky, and the value vu are received from the host processor 90.

As in Sq3A described above, the attention processor 19 of the memory system 1 receives the query qr, the key ky, and the value vu from the host processor 90 of the host device 9. As in Sq5 described above, the attention processor 19 adds the received key ky and value vu to the region corresponding to the layer<i> and the batch<j> in the KV cache 200 of the nonvolatile memory 11.

As in Sq6 described above, the attention processor 19 fetches the KV cache data used for the attention calculation, from the RAM 101.

In the present example, the KV cache data used for the attention calculation is prefetched. Therefore, the attention processor 19 can immediately acquire the KV cache data used for the attention calculation from the RAM 101 without waiting for the read period (load time) from the nonvolatile memory 11 to the RAM 101.

As in Sq8 described above, the attention processor 19 executes the attention calculation for the layer<i> and the batch<j> using the KV cache data that is prefetched into the RAM 101. As in Sq10A and Sq10B described above, the attention processor 19 stores the output data op resulting from the attention calculation in the RAM 101. As in Sq11 and Sq12 described above, the attention processor 19 sends the attention calculation completion notification Comp to the host device 9. The completion notification Comp is stored in the attention completion queue 915x of the host device 9.

As in Sq13A and Sq13B described above, depending on the detection of the completion notification Comp, the host processor 90 of the host device 9 sends the attention read command AttnRead from the attention submission queue 911x to the memory system 1. As in Sq14 and Sq15 described above, the output data op stored in the RAM 101 is transferred to the host device 9 according to the attention read command AttnRead. As in Sq16 described above, the host processor 90 performs feed-forward network processing using the output data op.

Through the above processing sequence, the calculation processing related to the layer<i> and the layer<j> is completed.

In the processing sequence according to the present example, the prefetching of the KV cache data used for the attention calculation in the memory system 1 is executed in parallel with the calculation of the query qr, the key ky, and the value vu in the host device 9. Thus, the read time of the KV cache data from the nonvolatile memory 11 is hidden in a background of the calculation of the query qr, the key ky, the value vu, and or the like in the host device 9. As a result, in the processing sequence according to the present example, the memory system 1 according to the present embodiment can send the result of the attention calculation to the host device 9 at a relatively high speed (short latency).

### (c) Summary

In the information processing device that executes the machine learning (for example, inference) of the large language model, the amount of data used for the machine learning is growing. The data structure (KV cache) related to the key and the value is used for the attention calculation in the large language model. The amount of data in the KV cache is increasing in proportion to the length of sentences input and output as targets for machine learning.

When a large number of GPUs are used to process a large amount of data in the KV cache, the cost of the information processing device increases.

In general, data such as data in a KV cache used in the machine learning is stored in a memory system (storage device) outside the device that calculates the answer to the question. During execution of the machine learning, a large amount of data is transferred from the memory system to the device. Therefore, in the general information processing device, the speed of the calculation processing tends to decrease due to an increase in the amount of data transferred from the memory system.

The memory system 1 according to the present embodiment includes the nonvolatile memory 11 that stores a large amount of data (for example, data related to the key ky and the value vu) used for the machine learning of the large language model, and also includes the attention processor 19 that uses the stored data to execute some of the calculation processing for the machine learning (for example, calculation of attention between words).

As a result, the memory system 1 according to the present embodiment executes the calculation processing using a large amount of data inside the memory system 1 without transferring the large amount of data to the external device (for example, the host device 9) of the memory system 1. The memory system 1 according to the present embodiment transfers the result of the calculation processing to the external device (for example, the host device 9) of the memory system 1.

Therefore, the memory system 1 according to the present embodiment can transfer the result (output data) of the calculation processing having the amount of data smaller than the amount of data of the KV cache used in the calculation processing to the external device of the memory system 1.

Accordingly, the memory system 1 according to the present embodiment can reduce the amount of data transferred to the external device of the memory system.

Moreover, the information processing device 1000 including the memory system 1 according to the present embodiment can reduce the time required for the calculation processing. Therefore, the information processing device 1000 including the memory system 1 according to the present embodiment can improve performance. Furthermore, the information processing device 1000 including the memory system 1 according to the present embodiment can prevent an increase in costs of the information processing device.

As described above, the memory system 1 according to the present embodiment can improve the efficiency of data transfer from the memory system to the host device.

### (2) Second Embodiment

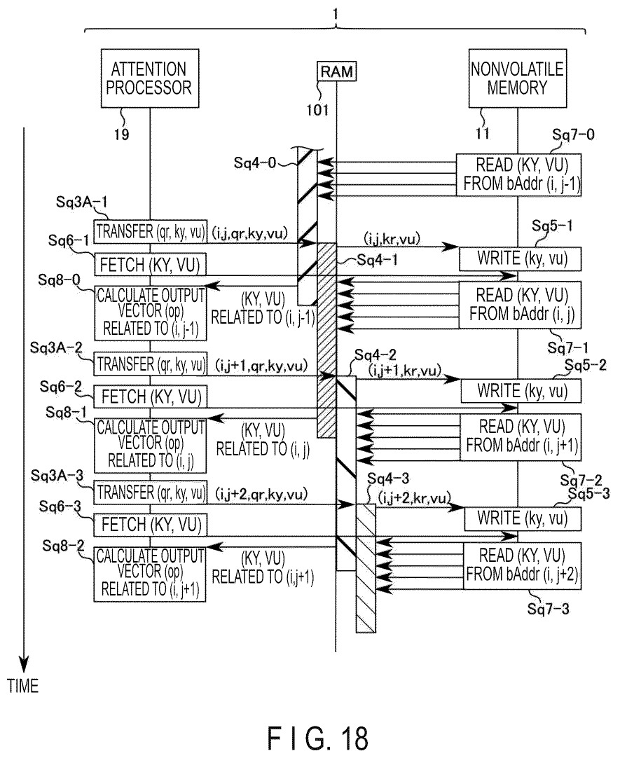

With reference to FIG. 18, a memory system according to a second embodiment will be described.

In a memory system 1 according to the second embodiment, a plurality of attention calculations may be executed by pipeline processing.

FIG. 18 is a sequence diagram illustrating pipeline processing of a plurality of attention calculations in the memory system 1 according to the second embodiment. In FIG. 18, processing sequences related to the attention processor 19, the nonvolatile memory 11, and the RAM 101 are extracted and illustrated.

As described above, the memory system 1 receives a plurality of attention calculation execution commands AttnWrite from the host device 9 via the attention submission queue 911x and the attention request FIFO 159. For example, the plurality of attention calculation execution commands AttnWrite designate batch IDs (ID<j−1>, ID<j>, ID<j+1>, and ID<j+2>) different from one another, respectively, and designate the same layer ID (ID<i>).

### <Sq3A-1, Sq4-1, and Sq5-1>

After sequences (Sq4-0 and Sq7-0) in which KV cache data for batch ID<j−1>and layer<i> according to a (j−1)-th attention calculation execution command AttnWrite is fetched from the nonvolatile memory 11 to the RAM 101, the attention processor 19 transfers a query qr, a key ky, and a value vu related to a batch ID<j> and a layer<i> according to a j-th attention calculation execution command AttnWrite to the RAM 101. The key ky and the value vu related for the batch ID<j> and the layer<i> are written into a region corresponding to a batch ID<j> and a layer<i> of the nonvolatile memory 11.

### <Sq6-1 and Sq7-1>

The attention processor 19 executes fetching of the KV cache data of the batch ID<j> and the layer<i>. Thus, the nonvolatile memory 11 transfers the KV cache data of the batch ID<j> and the layer<i> to the RAM 101. The KV cache data of the batch ID<j> and the layer<i> is stored in the RAM 101.

### <Sq8-0>

In parallel with a period during which the KV cache data of the batch ID<j> and the layer<i> according to the j-th attention calculation execution command AttnWrite is being transferred to the RAM 101, the attention processor 19 executes attention calculation using the KV cache data of the batch ID<j−1> and the layer<i> in the RAM 101 according to the (j−1)-th attention calculation execution command AttnWrite.

### <Sq3A-2, Sq4-2, and Sq5-2>

After the attention calculation related to the batch ID<j−1> and the layer<i> is completed, the attention processor 19 transfers a query qr, a key ky, and a value vu related to a batch ID<j+1> and a layer<i> according to a (j+1)-th attention calculation execution command AttnWrite to the RAM 101. The key ky and the value vu related to the batch ID<j+1> and the layer<i> are written to a region corresponding to a batch ID<j+1> and a layer<i> of the nonvolatile memory 11.

### <Sq6-2 and Sq7-2>

The attention processor 19 executes fetching of the KV cache data of the batch ID<j+1> and the layer<i>. Thus, the nonvolatile memory 11 transfers the KV cache data of the batch ID<j+1> and the layer<i> to the RAM 101. The KV cache data of the batch ID<j+1> and the layer<i> is stored in the RAM 101.

### <Sq8-1>

In parallel with a period during which the KV cache data of the batch ID<j+1> and the layer<i> according to the (j+1)-th attention calculation execution command AttnWrite is being transferred to the RAM 101, the attention processor 19 executes attention calculation using the KV cache data of the batch ID<j> and the layer<i> in the RAM 101 according to the j-th attention calculation execution command AttnWrite.

### <Sq3A-3, Sq4A-3, and Sq5-3>

After the attention calculation related to the batch ID<j> and the layer<i> is completed, the attention processor 19 transfers a query qr, a key ky, and a value vu related to a batch ID<j+2> and a layer<i> according to a (j+2)-th attention calculation execution command AttnWrite to the RAM 101. The key ky and the value vu related to the batch ID<j+2> and the layer<i> are written to the region corresponding to the batch ID<j+1> and the layer<i> of the nonvolatile memory 11.

### <Sq6-3 and Sq7-3>

The attention processor 19 executes fetching of the KV cache data of the batch ID<j+2> and the layer<i>. Thus, the nonvolatile memory 11 transfers the KV cache data of the batch ID<j+2> and the layer<i> to the RAM 101. The KV cache data of the batch ID<j+2> and the layer<i> is stored in the RAM 101.

### <Sq8-2>

In parallel with a period during which the KV cache data of the batch ID<j+2> and the layer<i> according to the (j+2)-th attention calculation execution command AttnWrite is being transferred to the RAM 101, the attention processor 19 executes attention calculation using the KV cache data of the batch ID<j+1> and the layer<i> in the RAM 101 according to the (j+1)-th attention calculation execution command AttnWrite.

As described above, the memory system 1 of the second embodiment can execute the plurality of attention calculations using the pipeline processing. Thus, the period of the attention calculation according to a certain attention calculation execution command AttnWrite overlaps in time with the period of reading the KV cache data for the attention calculation according to another attention calculation execution command AttnWrite. As a result, the memory system 1 according to the present embodiment can reduce the waiting time that may occur in the attention calculation in each of the plurality of commands AttnWrite.

As described above, the memory system 1 according to the present embodiment can increase the number of attention calculation execution commands AttnWrite that can be processed per unit time when the plurality of attention calculation execution commands AttnWrite are processed.

Therefore, the information processing device 1000 including the memory system 1 according to the present embodiment can reduce the time required for the calculation processing. Therefore, the information processing device 1000 including the memory system 1 according to the present embodiment can improve performance. Moreover, the memory system 1 according to the present embodiment can improve the efficiency of data transfer, similarly to the first embodiment.

### (3) Third Embodiment

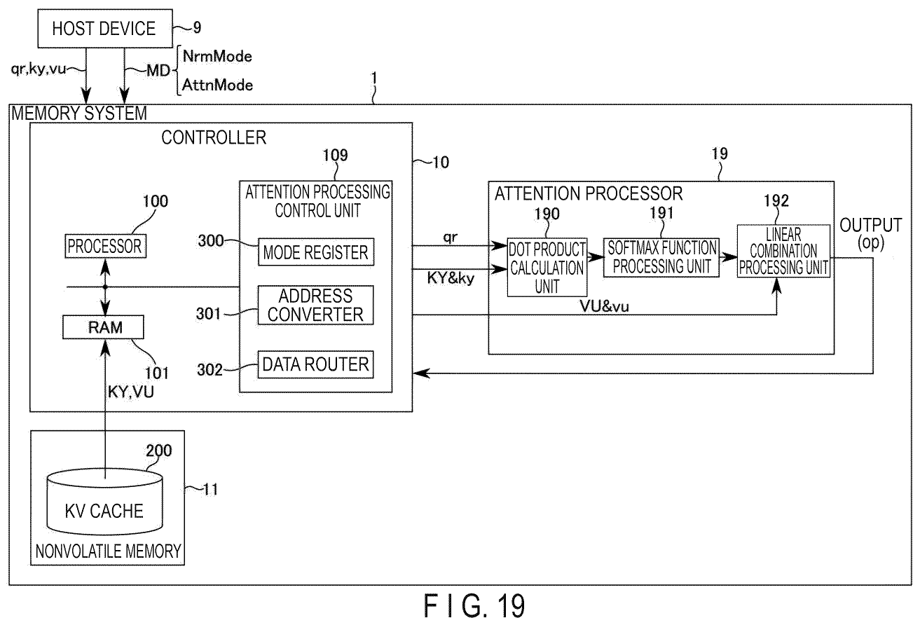

With reference to FIG. 19, a memory system according to a third embodiment will be described.

FIG. 19 is a block diagram illustrating an example of a configuration of a memory system 1 according to the third embodiment.

The memory system 1 according to the present embodiment illustrated in FIG. 19 performs, based on mode information notified from the host device 9, switching between various operation modes (hereinafter, referred to a normal mode) for the normal region 610 in the normal memory system and an operation mode (hereinafter, referred to as an attention mode) in which the attention processing is executed using the KV cache 200.

In the memory system 1 of FIG. 19, the attention processing control unit 109 further includes a mode register 300, an address converter 301, and a data router 302.

The mode register 300 stores mode information MD received from the host device 9. The mode information MD is information indicating the normal mode and the attention mode designated from the host device 9. For example, the mode information includes a command NrmMode indicating the normal mode, and a command AttnMode indicating the attention processing mode. For example, when the memory system 1 is an SSD, the mode information MD is set in a reserve field of a command conforming to an NVMe protocol. For example, when the memory system 1 conforms to a CXL standard, the mode information MD is set in a metadata field of a command conforming to the CXL standard. The mode information MD may be notified to the memory system 1 from the host device 9 using a device register (not illustrated) without using a command.

A rule (protocol) may be determined between the host device 9 and the memory system 1 such that various normal commands from a specific queue are recognized as commands for attention processing.

When mode information MD is the attention mode AttnMode, the address converter 301 converts the address from the host device 9 into an address in which data used for attention processing is stored. When the mode information MD is the normal mode NrmMode, the address converter 301 performs address conversion to operate as a normal memory system.

The data router 302 controls data transfer to read the key data KY and the value data VU from the KV cache 200 of the nonvolatile memory 11 according to the mode information MD (when the mode information MD is the attention mode AttnMode). The data router 302 sends the read key data KY and value data VU to the attention processor 19 together with the query qr, the key ky, and the value vu from the host device 9. The data router 302 controls data transfer to write the key ky and the value vu from the host device 9 to the KV cache 200 of the nonvolatile memory 11.

The attention processor 19 reinterprets normal commands of a write command, a read command and the like sent from the host device 9 as commands for attention processing based on the mode information MD (when the mode information MD is the attention mode AttnMode), under the control of the attention processing control unit 109.

For example, out of 64 bits indicating an address for designating a write destination in the write command, the upper 32 bits are interpreted as a batch ID, and the lower 32 bits are interpreted as a layer ID; and the address of the host buffer storing the write data is interpreted as an address wAddr in which the query qr, the key ky, and the value vu are stored.

For example, out of 64 bits indicating an address for designating a read source in the read command, the upper 32 bits are interpreted as a batch ID, and the lower 32 bits are interpreted as a layer ID; and the address of the host buffer storing the read data is interpreted as an address rAddr in which the result of the attention calculation is stored.

Based on the reinterpreted command, the attention processor 19 executes the attention calculation, adds a new key ky and a new value vu to the nonvolatile memory 11, outputs the result of the attention calculation, deletes the KV cache data, and so on.

In this way, the memory system 1 according to the present embodiment can implement the function of the normal memory system and can execute the attention calculation in the memory system 1, based on the mode information MD (NrmMode or AttnMode) indicating whether to operate as the normal memory system or to execute the attention processing.

Accordingly, the memory system 1 according to the present embodiment can reduce the amount of data transferred between the host device 9 and the memory system 1.

As a result, the memory system 1 according to the third embodiment can improve the efficiency of data transfer within the memory system, similarly to the memory systems according to the first and second embodiments described above.

### (4) Others

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a nonvolatile memory;
a processor configured to execute attention calculation to generate an attention indicating a correlation among words in a large language model; and
a controller electrically connected to the nonvolatile memory and the processor, the controller configured to:
store, in a first memory region set in the nonvolatile memory, a plurality of key-value pairs used for the attention calculation, each of the key-value pairs including a first key and a first value associated with each other;
control the processor to execute the attention calculation using the plurality of key-value pairs read from the nonvolatile memory and input data received from a host device, which is external to the memory system, the input data including a query, a second key, and a second value generated from a question to be processed in the large language model; and
transmit output data indicating a result of the attention calculation to the host device.

2. The memory system according to claim 1, wherein the controller is configured to control the processor to start executing the attention calculation in response to a first command received from the host device.

3. The memory system according to claim 2, further comprising:
a volatile memory,
wherein the controller is configured to, in response to the first command, transfer the plurality of key-value pairs from the first memory region of the nonvolatile memory to the volatile memory.

4. The memory system according to claim 3, wherein the controller is configured to receive the input data in association with the first command and store the input data in the volatile memory.

5. The memory system according to claim 4, wherein the processor is configured to execute the attention calculation using the plurality of key-value pairs and the input data stored in the volatile memory.

6. The memory system according to claim 3, wherein
the controller is configured to read the plurality of key-value pairs from the first memory region of the nonvolatile memory and store the obtained plurality of key-value pairs in the volatile memory in response to a second command received from the host device,
the second command is different from the first command, and the controller is configured to not control the processor to start executing the attention calculation in response to the second command.

7. The memory system according to claim 2, wherein the controller is configured to receive the input data in association with the first command and store the input data in the nonvolatile memory.

8. The memory system according to claim 2, further comprising:
a volatile memory,
wherein the processor is configured to execute the attention calculation using the plurality of key-value pairs read from the nonvolatile memory and the input data received from the host device, in parallel to transfer of data used for a subsequent attention calculation from the first memory region of the nonvolatile memory to the volatile memory.

9. The memory system according to claim 1, wherein the controller is configured to transmit the output data to the host device in response to a third command received from the host device.

10. The memory system according to claim 1, wherein the controller is configured to set the first memory region of the nonvolatile memory in accordance with a parameter value included in a fourth command received from the host device.

11. The memory system according to claim 1, wherein the controller is configured to delete the plurality of key-value pairs stored in the nonvolatile memory in response to a fifth command received from the host device.

12. The memory system according to claim 1, wherein the processor is configured to, during the attention calculation:
calculate, with respect to each of the first keys and the second key, an inner product of the query and the key;
normalize the inner products using a softmax function; and
calculate a linear combination of the first values and the second value each multiplied with the corresponding normalized inner product.

13. The memory system according to claim 1, further comprising:
a command queue,
the controller is configured to store commands for the attention calculation received from the host device separately from commands irrelevant to the attention calculation in the command queue.

14. The memory system according to claim 1, wherein the controller is configured to operate in a plurality of operation modes, including a first mode, in which the controller controls the processor to execute the attention calculation, and a second mode, in which the controller does not control the processor to execute the attention calculation.

15. The memory system according to claim 14, wherein the controller is configured to switch an operation mode thereof based on a command received from the host device.

16. The memory system according to claim 14, wherein the controller is configured to:
set a second memory region in the nonvolatile memory, separately from the first memory region; and
store data received from the host device during the second mode in the second memory region, and not in the first memory region.

17. The memory system according to claim 14, wherein the controller includes a register and is configured to store, in the register, information indicating an operation mode thereof.

18. An information processing device comprising:
the memory system according to claim 1; and
the host device configured to:
transmit the input data to the memory system;
receive the output data from the memory system; and
perform feed-forward processing in the large language model using the output data.

19. A control method of a memory system including a nonvolatile memory and a processor configured to execute attention calculation to generate an attention indicating a correlation among words in a large language model, the method comprising:
storing, in a first memory region set in the nonvolatile memory, a plurality of key-value pairs used for the attention calculation, each of the key-value pairs including a first key and a first value associated with each other;
controlling the processor to execute the attention calculation using the plurality of key-value pairs read from the nonvolatile memory and input data received from a host device, which is external to the memory system, via the controller, the input data including a query, a second key, and a second value generated from a question to be processed in the large language model; and
transmitting output data indicating a result of the attention calculation to the host device.

20. The control method according to claim 19, further comprising controlling the processor to start executing the attention calculation in response to a first command received from the host device.
